(19) United States
(12) Patent Application Publication
(10) Pub. No.: US 2014/0241322 A1
(43) Pub. Date: Aug. 28, 2014

(54) METHOD AND APPARATUS FOR CONTROLLING CONNECTION SWITCHING ACCORDING TO THE AMOUNT OF DATA NOT TRANSFERED

(71) Applicant: AIRPLUG INC., Seoul (KR)

(72) Inventors: Soon Uk Kim, Anyang-si (KR); Seung Jun Lee, Seoul (KR); Jin Soo Park, Seoul (KR)

(73) Assignee: AIRPPLUG INC., Seoul (KR)

(21) Appl. No.: 14/352,565

(22) PCT Filed: Oct. 18, 2012
(86) PCT No.: PCT/KR2012/008547

§ 371 Date: Apr. 17, 2014

(30) Foreign Application Priority Data
Oct. 24, 2011 (KR) 10-2011-0108643

(51) Int. Cl. H04W 36/00

(52) U.S. Cl. CPC H04W 36/0016
USPC 370/331

(57) ABSTRACT

A mobile communication terminal according to the present invention comprises a processing unit for carrying out an operation intended for a data object such as content or a program, a channel builder for establishing a data channel for providing a data object to, for example, a player or a browser; and a data transceiver, while being connected to one of communication networks among a plurality of heterogeneous networks, for receiving a data object from an external server through the communication network, providing the received data to the processing unit through the data channel, checking the amount of remaining data to receive from the data object.

### TECHNICAL FIELD

The present invention is related to a method for connection switching to use a plurality of heterogeneous networks or different access points selectively, each of which providing a service region with different characteristics or providing service quality differing from the others, and an apparatus for the method.

### BACKGROUND ART

As mobile communication networks are advanced, users are now able to access various kinds of information for their needs through browsing or enjoy desired contents through downloading or streaming the contents regardless of their current location by using a smart phone, table computer, and the like, not to mention a mobile phone (in what follows, it is called collectively a “mobile communication terminal”).

A mobile communication terminal capable of receiving location-independent data services always maintains a state of being connected to one of a plurality of heterogeneous networks relying on different infrastructures from each other accessed through wireless communication resources of the terminal, namely a state capable of data communication by receiving a connection IP address.

For example, if a communication network such as a Wi-Fi LAN network providing high-speed wireless data services is currently available, the mobile communication terminal maintains a state of being connected to the communication network; otherwise, the mobile communication terminal receives a connection IP address from a mobile phone network such as CDMA2000 or W-CDMA network covering a broad service area and maintains a connected state for data services. Furthermore, if the two different types of communication networks are both available, the mobile communication terminal maintains a state of being connected to the Wi-Fi LAN network usually providing high-speed data access unless access to the network is deliberately suppressed otherwise, thus always maintaining a state of being connected to a single communication network to receive data services.

Since a Wi-Fi LAN network is available only in a scattered, local service area, however, the users have no choice but to use data services while consistency or continuity of the data services is not guaranteed. Therefore, most of the users of mobile communication terminals use data services based on a mobile phone network supporting a broad service area; since a data service through the mobile phone network is charged on the basis of data usage, however, the users tend to use the Wi-Fi LAN network as much as possible while the Wi-Fi LAN network is available.

In such a communication environment, if a Wi-Fi LAN network becomes available while the user is watching streaming contents provided from an arbitrary server by using his or her mobile communication terminal connected to a mobile phone network, the user may attempt connection switching to the Wi-Fi LAN network for fear of or from concern about the cost incurred due to the amount of streaming data. If the connection switching is carried out, however, the connection IP allocated to the mobile communication terminal is changed; thus, the user has to perform a tricky procedure of demanding the streaming contents again, specifying the last part that the user has watched and playing the contents from the specified part.

Moreover, suppose the user takes the trouble to perform the tricky procedure to stream the same contents through the Wi-Fi LAN network from the previous scene of the contents. If the amount of remaining data that should be received since the moment of streaming through the Wi-Fi LAN network is small, it may be more advantageous from the standpoint of resource management to maintain the previous access network instead of carrying out connection switching.

### DISCLOSURE

### Technical Problem

One object of the present invention is to provide a method and apparatus for enabling seamless and continuous play even if connection switching is carried out while data is received through an arbitrary one communication network.

Another object of the present invention is to provide a method and apparatus for enabling switching of communication networks meant to receive data by taking account of the cost incurred as the user uses a communication network or ensuring smooth data services therefrom.

A yet another object of the present invention is to provide a method and apparatus for selectively switching a plurality of heterogeneous networks or access points in a single communication network and enabling them to be used for data reception or transmission while minimizing unnecessary switching of communication networks.

The scope of the present invention is not necessarily limited to the above explicit statements. Rather, the scope of the present invention covers anything to accomplish effects that could be derived from the specific and illustrative explanations of the present invention below.

### Technical Solution

A mobile communication terminal capable of accessing a wireless communication network in accordance with one aspect of the present invention comprises: a channel builder adapted to configure a data channel for providing data of a data object to a processing unit for conducting an intended operation for the data object; and a data transceiver configured to receive data of a data object from an external server, in a state of being connected to a communication network among a plurality of heterogeneous networks including a first communication network and a second communication network, through the connected communication network, to check an amount of remaining data, not received, of the data object while providing the received data to the processing unit through the data channel, and in case of a current state being corresponding to one of conditions for connection switching, to switch connection if a value reflecting the checked amount of remaining data is greater than a value of a determined criterion, and not to switch connection if smaller than the value of the determined criterion.

In one embodiment of the present invention, the second communication network requires no cost to a user using a data service or a smaller cost, excluding fixed cost, than the first communication network, or the second communication network is a network whose service areas are relatively localized and scattered compared with those of the first communication network.

In one embodiment of the present invention, the conditions for connection switching may comprise: a first condition that a communication network or an access point through which data of the data object is received is in a poor communication state; a second condition that another communication network providing better service quality than a communication network through which data of the data object is received is available; a third condition that another access point providing better communication property than an access point through which data of the data object is received is available; or a fourth condition that another communication network requiring no cost to a user using a data service or a smaller cost, excluding fixed cost, than a communication network through which data of the data object is received is available. In the present embodiment, the data transceiver may deem that the first condition is satisfied if an amount of remaining data, not provided to the processing unit, in the data channel is decreasing.

In one embodiment of the present invention, the data transceiver is configured to: check an amount of currently unprocessed data, not provided to the processing unit, in the data channel; calculate time required for the checked amount of unprocessed data to be exhausted; and determine the criterion based on the calculated time. In the present embodiment, the data transceiver is configured to derive the time of data exhaustion from a value obtained by dividing the checked amount of unprocessed data by a speed at which data of a data object is provided to the processing unit through the data channel. Alternatively, the data transceiver may be configured to derive the time of data exhaustion from a value obtained by dividing the checked amount of unprocessed data by another value that is obtained by subtracting a speed of receiving data of a data object from a speed at which data of the data object is provided to the processing unit through the data channel.

In another embodiment of the present invention, the data transceiver is configured to determine the criterion based on switching time required for connection switching. In the present embodiment, the switching time is determined to be a time corresponding to the connection switching chosen from among time values set respectively with respect to switching from the first communication network to the second communication network, switching from the second communication network to the first communication network, and switching between access points belonging to the second communication network. Alternatively, the switching time may be obtained from an average of time values corresponding to the connection switching among collected time values required for connection between the first communication network and an arbitrary access point belonging to the second communication network or between an arbitrary pair of access points belonging to the second communication network.

In still another embodiment of the present invention, the data transceiver is configured to determine the criterion to be a time obtained by subtracting elapsed time during the data receiving from a time specified for completion of receiving the data object, or to be currently remaining time until a point of time specified for completion of receiving the data object.

In one embodiment of the present invention, the data transceiver is further configured to compare the value reflecting the checked amount of remaining data with respective values set according to a plurality of predetermined criteria, and not to switch connection in case that the value reflecting the checked amount is smaller than each of the values.

In one embodiment of the present invention, the data transceiver is configured to reduce relative magnitude of a value of the criterion to a value reflecting the amount of remaining data if a speed of receiving data of the data object is decreased. In the present embodiment, the value reflecting the amount of remaining data and the value of the criterion are a time value, and the value reflecting the amount of remaining data is a value obtained by dividing the amount of remaining data by a speed of receiving data of the data object. Alternatively, the value reflecting the amount of remaining data and the value of the criterion are a value representing data size, and the value of the criterion is a value obtained by multiplying the criterion expressed in time by a speed of receiving data of the data object.

In one embodiment of the present invention, the connection switching is to be made between the first communication network and the second communication network or between access points belonging to the second communication network.

In one embodiment of the present invention, the mobile communication terminal is configured to access all of the plurality of heterogeneous networks.

In another embodiment of the present invention, the mobile communication terminal is configured to access single network of the second communication network.

In one embodiment of the present invention, the data transceiver is further configured to set the criterion applied for the connection switching to be made from the first communication network to the second communication network lower than the criterion applied for the connection switching to be made from the second communication network to the first communication network.

In one embodiment of the present invention, the connection switching is to be made between the first communication network and the second communication network and the data transceiver is further configured to let down the determined criterion if a current mode is meant to restrain incurrence of cost and a currently connected communication network is the first communication network. In addition, the data transceiver is further configured to raise the determined criterion if a current mode is meant to put a high priority on convenience in using data service and a currently connected communication network is the first communication network.

In one embodiment of the present invention, the mobile communication terminal may further comprises a mode determining unit configured to determine a mode automatically, from among a plurality of modes including a mode meant to restrain incurrence of cost and a mode meant to put a high priority on convenience in using data service, based on data usage with respect to the first communication network, a rate schedule information of a user, and a remaining days in terms of a rate schedule period. In the present embodiment, the data transceiver is further configured to selectively adjust the determined criterion according to the determined mode.

In one embodiment of the present invention, the data transceiver is further configured to let down the determined criterion if a variation range of communication property of a communication network or an access point currently connected is larger than a predetermined limit. The communication property may include strength of a received signal or a data receiving speed.

In one embodiment of the present invention, the data transceiver may be further configured to raise the determined criterion if a variation range of the communication property of a target communication network or a target access point to which connection is switched is larger than a predetermined limit.

In one embodiment of the present invention, the data transceiver may be further configured to let down the determined criterion if communication property of a target communication network or a target access point to which connection is switched is better than a predetermined reference.

In one embodiment of the present invention, the data transceiver is configured to adjust the determined criterion based on length of a time obtained by subtracting elapsed time during the data receiving from a time specified for completion of receiving the data object, or based on length of a currently remaining time until a point of time specified for completion of receiving the data object. In the present embodiment, the data transceiver is further configured to raise the determined criterion if the length of time is longer than a time reference in case that a currently connected communication network is the second communication network wherein the time reference may be determined from a value obtained by dividing the amount of remaining data not received by a measured or estimated transmission speed of a currently connected communication network. The data transceiver may let down the determined criterion if the length of time is shorter than the time reference.

In one embodiment of the present invention, data of the data object is received in a streaming manner which allows playing content data simultaneously with receiving data or in a downloading manner which stores received content data into a file.

In one embodiment of the present invention, the data transceiver is further configured: when connection switching is completed, to receive the data object successively by transmitting a request compliant with communication protocol, which demands data from a position subsequent to data of the data object received from a communication network or an access point previously connected, to the external server through another communication network or another access point to which connection is made; and to provide the successively received data of the data object to the processing unit through the data channel.

In one embodiment of the present invention, the processing unit is configured to comprise a media data processing unit for decoding data of the data object retrieved or received from the data channel, or for causing the retrieved or received data to be decoded.

A mobile communication terminal capable of accessing a wireless communication network in accordance with another aspect of the present invention comprises: a data transceiver configured to check an amount of remaining data, not received, of a data object while receiving data of the data object from an external server in a state of being connected to one communication network among a plurality of heterogeneous networks, and in case of a current state being corresponding to one of conditions for connection switching, to switch connection if a value reflecting the checked amount of remaining data is greater than a value of a determined criterion, and not to switch connection if smaller than the value of the determined criterion; and a recording unit configured to record the received data of the data object in a storage means.

Another mobile communication terminal capable of accessing a wireless communication network in accordance with another aspect of the present invention comprises: a data obtaining unit configured to obtain data of a selected data object; and a data transceiver configured to check an amount of remaining data, not transmitted, of the data object while transmitting data of the data object being obtained by the data obtaining unit to an external server in a state of being connected to one communication network among a plurality of heterogeneous networks, and in case of a current state being corresponding to one of conditions for connection switching, to switch connection if a value reflecting the checked amount of remaining data is greater than a value of a determined criterion, and not to switch connection if smaller than the value of the criterion.

A method for receiving data as switching connection selectively in accordance with another aspect of the present invention comprises: a first step of receiving data of a data object from an external server through a connected network in an environment of a plurality of heterogeneous networks; a second step of checking an amount of remaining data, not received, of the data object while providing the received data to a processing unit for conducting an intended operation for the data object; and a third step of in case of a current state being corresponding to one of conditions for connection switching, comparing a value reflecting the checked amount of remaining data with a value of a determined criterion and switching connection selectively according to a result of the comparing. And, the third step does not switch connection if the value reflecting the amount of remaining data is smaller than the value of the determined criterion.

Another method for transmitting data as switching connection selectively in accordance with another aspect of the present invention comprises: a first step of obtaining data of a selected data object; a second step of checking an amount of remaining data, not transmitted, of the data object while transmitting the obtained data to an external server through a connected network in an environment of a plurality of heterogeneous networks; and a third step of in case of a current state being corresponding to one of conditions for connection switching, comparing a value reflecting the checked amount of remaining data with a value of a determined criterion and switching connection selectively according to a result of the comparing. And, the third step does not switch connection if the value reflecting the amount of remaining data is smaller than the value of the determined criterion.

An apparatus equipped with a storage storing for programs to be provided through a network in accordance with another aspect of the present invention comprises: communication means being capable of transceiving data through communication with an outside entity; and storing means storing an application to be run on a mobile communication terminal, the application being transmitted through the communication means, wherein the application includes a program structure to accomplish operations, in case of being run on the mobile communication terminal, that comprise: configuring a data channel; receiving data of a data object from an external server, in a state of being connected to a communication network in an environment of a plurality of connectable heterogeneous networks, through the connected communication network; providing the received data to a processing unit through the data channel; checking an amount of remaining data, not received, of the data object; and in case of a current state being corresponding to one of conditions for connection switching, comparing a first value reflecting the checked amount of remaining data with a second value of a determined criterion and retaining current connection if the first value is smaller than the second value, but switching connection if larger than the second value.

In one embodiment of the present invention, the application may further include another program structure to accomplish operations, in case of being run on the mobile communication terminal, that comprise: retrieving or receiving data of a data object from the data channel; and conducting one operation of decoding the retrieved or received data, causing the retrieved or received data, and storing the retrieved or received data as a file.

An apparatus equipped with a storage storing for programs to be provided through a network in accordance with another aspect of the present invention comprises: communication means being capable of transceiving data through communication with an outside entity; and storing means storing an application to be run on a mobile communication terminal, the application being transmitted through the communication means, wherein the application includes a program structure to accomplish operations, in case of being run on the mobile communication terminal, that comprise: receiving data of a data object from an external server, in a state of being connected to a communication networks in an environment of a plurality of heterogeneous networks, through the connected communication network; checking an amount of remaining data, not received, of the data object; in case of a current state being corresponding to one of conditions for connection switching, retaining current connection if a value reflecting the checked amount of the remaining data is smaller than a value of a determined criterion, but switching connection if larger than the value of the determined criterion; and recording the received data of the data object in a storage means.

Another apparatus for providing programs in accordance with another aspect of the present invention comprises storing means storing an application that includes a program structure to accomplish operations, in case of being run on a mobile communication terminal, that comprise: obtaining data of a selected data object; transmitting data of the data object to an external server, in a state of being connected to a communication network in an environment of a plurality of heterogeneous networks, through the connected communication network; checking an amount of remaining data, not transmitted, of the data object; and in case of a current state being corresponding to one of conditions for connection switching, retaining current connection if a value reflecting the checked amount of remaining data is smaller than a value of a determined criterion, but switching connection if larger than the value of the determined criterion.

### Advantageous Effects

The present invention described above or at least one embodiment of the present invention described in detail below with reference to appended drawings, to suppress incurrence of costs or ensure consistence of data services, enables content data to be played continuously even if connection switching is carried out to a different communication network in the middle of receiving and playing the content data.

Also, the present invention suppresses a transitional load on communication resources of communication networks and mobile communication terminals by selectively switching communication networks while guaranteeing continuity of play of content data or selectively using a communication network optimized for a given condition so that unnecessary connection switching of communication networks can be prevented in the middle of receiving a data object, for example, a content file, arbitrary segment file constituting a live stream, program file, data file, and the like.

Therefore, according to the present invention, those users who watch content data or live streams through their mobile communication terminal or request downloading or uploading of a data object can fully enjoy the contents, obtain the data object in their needs, or store the data object in an external server in such a situation where conditions for using a service are satisfied according to the users' needs or where a transitional load on communication resources is minimized.

### DESCRIPTION OF DRAWINGS

FIG. 1 illustrates a logical structure of constituting elements of a mobile communication terminal according to one embodiment of the present invention in which an embodiment of a method for controlling connection switching of communication networks according to the amount of unreceived data and their connection to external entities as seen from the programming point of view;

FIG. 2 illustrates a structure of a mobile communication terminal implementing one method for controlling connection switching of communication networks according to the amount of unreceived data according to one embodiment of the present invention;

FIG. 3 illustrates structures of a media player receiving and decoding media data while controlling connection switching of communication networks based on the amount of unreceived data according to one embodiment of the present invention, together with part of constituting elements related to the structures within a mobile communication terminal;

FIGS. 4 and 5 are examples of a flow diagram illustrating a method for controlling connection switching of communication networks based on the amount of unreceived data according to one embodiment of the present invention;

FIGS. 6 and 7 illustrate procedures for continuous play of content data by taking over data at the time of changing connection IP addresses due to connection switching of communication networks according to one embodiment of the present invention;

FIG. 8 is an example of a revised HTTP request, transmitted to take over content data at the time of changing a connection IP address according to one embodiment of the present invention;

FIG. 9 illustrates the case according to one embodiment of the present invention, where a reference value for determining whether to perform connection switching based on the amount of unreceived data is adjusted by various modes determined by taking account of incurrence of costs from using a data service and consistency of using the data service;

FIG. 10 illustrates a media player according to one embodiment of the present invention utilizing a mode, which is determined by an external entity, together with constituting elements of the media player;

FIG. 11 illustrates an example according to another embodiment of the present invention, where constituting elements controlling connection switching based on the amount of unreceived data are implemented as separate objects independent from a processing unit which processes a data object;

FIG. 12 illustrates an example according to a yet another embodiment of the present invention, where constituting elements controlling connection switching based on the amount of unreceived data are implemented in a processing unit which processes a data object; and

FIG. 13 illustrates a data object processing unit according to a still another embodiment of the present invention, controlling connection switching based on the amount of unreceived data while transmitting a data object to an external server.

### MODE FOR INVENTION

In what follows, embodiments of the present invention will be described in detail with reference to appended drawings.

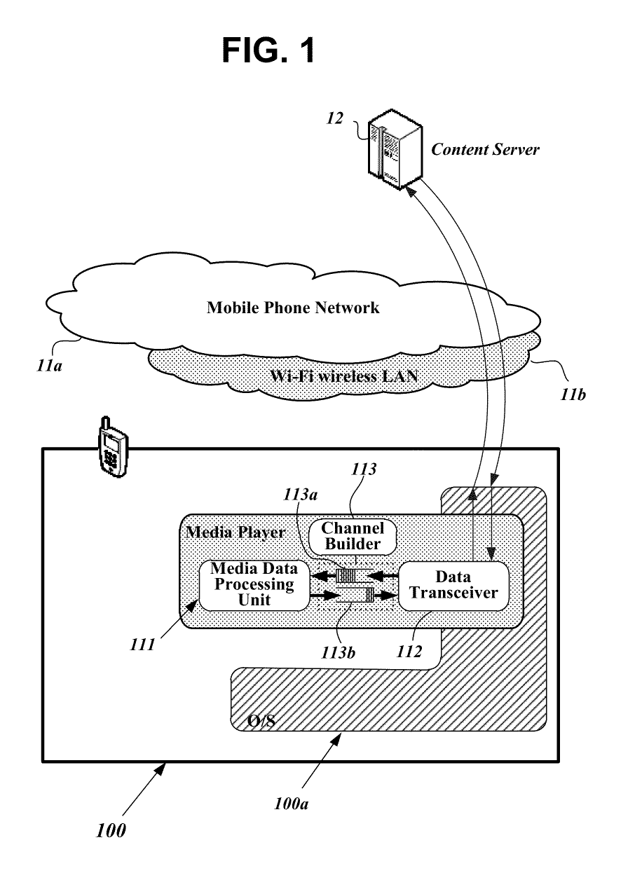

FIG. 1 illustrates a logical structure of constituting elements of a mobile communication terminal according to one embodiment of the present invention in which an embodiment of a method for controlling connection switching of communication networks according to the amount of unreceived data and their connection to external entities as seen from the programming point of view.

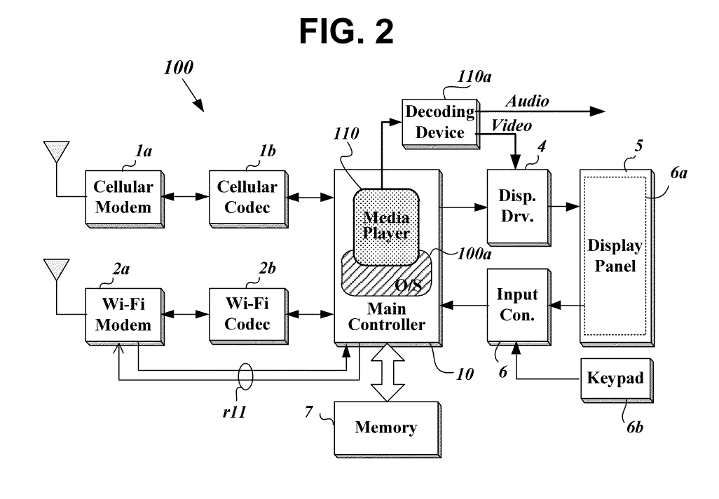

The logical structure of the mobile communication terminal 100 from the programming point of view as illustrated in the figure comprises a conventional operating system such as Android, IOS, and Windows intended for driving hardware resources (illustrated in FIG. 2) of the mobile communication terminal 100 and exchanging appropriate signals and/or information with the corresponding resources or an operating system 100a specific to the present invention; and a media player 110 executed under the operating system 100a. Besides the media player 110, various applications can be implemented under the operating system 100a; however, since they are not necessary to describe the technical principles and scope of the present invention, conventional applications (hereinafter, they are called “applications” for short) will not be described.

The media player 110 in the figure (or a data object processor described in the embodiments below) is a process or an application implemented in the mobile communication terminal 100, which can be provided in the form of software having a structure comprising program codes executed under the operating system 100a as shown in FIG. 1. In case the media player 110 is provided in the form of software, the media player 110 stored in a high-capacity storage means of a particular server may be downloaded and executed in the mobile communication terminal 100 through a conventional on-line purchasing process from the particular server connected to a communication network. Depending on situations, part of functions described in detail below can be implemented in the form of middleware or in the form of a platform for the terminal. Also, by incorporating a hardware component, the media player 110 can perform part of the functions described in detail below through the hardware component. Therefore, the technical scope of the present invention is not limited by the resources employed for implementation of the media player 110, the structure and operating method of which are described in detail through various embodiments according to the present invention.

In one embodiment according to the present invention, the media player 110 comprises a media data processing unit 111 which decodes a received data object, for example, content data of audio and/or video attribute; and a data transceiver 112 creating a communication socket through an API (Application Program Interface) provided by the operating system 100a and communicating data exchanged to and from the media data processing unit 111 with the external entities through the created communication socket as a sub-process. The media player 111 further comprises a channel builder 113 which allocates or creates a receiving buffer 113a and transmission buffer 113b used as a data channel for data transmission or exchange between the media data processing unit 111 and the data transceiver 112. In another embodiment according to the present invention, the transmission buffer may not be employed. In the present embodiment, the media data processing unit 111 provides the data transceiver 112 with data or requests to be transmitted to an external server according to the user's request through parameterization, and the data transceiver 112, in accordance with the parameterization, creates a request compliant with communication specifications, for example, HTTP Request and transmits the created request. In another embodiment according to the present invention, a UI processing unit intended for a function of processing user requests can be implemented as an independent process separately from the media data processing unit 111. In the present embodiment, the UI processing unit provides the data transceiver 112 with data or requests to be transmitted to an external server according to the user's request through parameterization.

In one embodiment according to the present invention, the channel builder 113, instead of using the buffer which stores media data in a sequential order, may allocate a memory space shared by the media data processing unit 111 and the data transceiver 112 and use the memory space as a data channel. In this case, media data can be delivered between the two units by recording media data at an arbitrary position of the shared memory space and informing of the recording position.

The data transceiver 112 identifies a current communication network that can be accessed among a plurality of available heterogeneous networks 11a, 11b through the operating system 110a and communicates data with an external server (for example, the content server 12 in the figure) through a communication network relevant to an operating condition by employing a connection IP address allocated by the communication network or by demanding a different communication network to allocate a connection IP address. Also, to perform data buffering seamlessly in the receiving buffer 113a so that continuity of content being played or integrity of a file being received can be ensured even in the middle of switching to a different communication network, the data transceiver 112 performs the operation of creating a request compliant with required communication protocol, for example, an HTTP Request and transmitting the created request. Such an operation of the data transceiver 112 will be described in detail below. And the media data processing unit 111 can also create a request compliant with communication protocol according to the user's request and delivers the created request to the data transceiver 112 through the transmission buffer 113b, thereby transmitting the created request to the external server.

In one embodiment according to the present invention, the data transceiver 112, media data processing unit 111, and channel builder 113 can be implemented together as a single process run under the operating system 100a. In this case, exchange of information or data among them can be carried out by using global variables, local variables, or arguments and/or return values of local functions. Therefore, the technical principles, scope, and expectations of the present invention do not necessarily presume or require that the data transceiver 112, media data processing unit 111, and channel builder 113 have to be separated from each other and implemented as separate processes, but the technical principles, scope, and expectations can also be realized even when individual functions described below are implemented by a single process.

The mobile communication terminal 100 having a logical structure of FIG. 1 generally comprises such hardware components as shown in FIG. 2 and can represent any one of a smart phone capable of accessing a wireless communication network such as a public mobile phone network or a high-speed wireless data network, tablet computer, and a notebook computer equipped with a function of a mobile phone. To provide specific descriptions of the block diagram in the figure, the mobile communication terminal 100 comprises a cellular modem 1a (which is a constituting element including a module processing RF signals) communicating with a cellular network by modulating or demodulating a signal according to a predetermined method employed for a public mobile phone network, for example, a 2G, 3G, or 4G cellular mobile phone network (hereinafter, it is called collectively “cellular network”); a cellular codec 1b encoding data or decoding encoded data according to communication protocol employed for the cellular network; a Wi-Fi modem 2a (which is a constituting element including a module processing RF signals) communicating with a high-speed wireless data network, for example, a Wi-Fi LAN network (hereinafter, it is called a “Wi-Fi network”) by modulating or demodulating signals according to a predetermined method employed for the wireless data network; a Wi-Fi codec 2b encoding data or decoding encoded data according to communication protocol employed for the Wi-Fi network; a display panel 5 for visual display of an image, characters, and so on; a display driving unit 4 driving the display panel 5 for arbitrary data to be displayed visually on the display panel 5; a decoder 110a decoding input encoded image and audio data and outputting the decoded image and audio data as image and audio signals; a touch sensor 6a attached at the front of the display panel 5; a keypad 6b equipped with keys and/or buttons; an input control unit 6 sensing a user input and/or selection applied to the touch sensor 6a and keypad 6b and outputting input information in accordance with the sensing result; a main controller 10 communicating data with the constituting elements or controlling them to carry out operation according to input information from the input control unit 6 or controlling the display driving unit 4 for display of a user interface (UI) intended for receiving the user's selection; and a memory 7 providing data storage space required for operation of the main controller 10.

And the main controller 10 enables the operating system 100a to perform intended functions by executing given command codes and also by executing command codes of the media player 110, enables the media player 110 to carry out operations to be described in detail below. In particular, the media data processing unit 111 of the media player 110, if needed, can apply the decoding operation performed in hardware by the decoder 110a to encoded image or audio data blocks through an appropriate API (Application Program Interface) provided by the operating system 100a.

The structure of the mobile communication terminal 100 illustrated in FIG. 2 is only an example intended to describe embodiments of the present invention in a specific and illustrative manner to help understand the technical principles and scope of the present invention. Mobile terminals implementing the technical principles of the present invention can further include constituting elements providing various functions not shown in FIG. 2 or exclude constituting elements illustrated and moreover, hardware elements can be implemented by software and vice versa.

In what follows, described will be a process of receiving content data and changing a method for using communication networks while receiving content data is carried out in the mobile communication terminal 100, the logical structure of which is illustrated in FIG. 1 with respect to the media player 110.

First of all, the user activates a browser through an appropriate user interface (UI) provided by the main controller 10, where the user interface is implemented in an input and output unit (for example, the display panel 5, touch sensor 6a, keypad 6b, and so on) installed in the mobile communication terminal 100. If the user selects one data object, for example, video content file provided by a particular server, for example, the content server 12 illustrated in the figure and requests the content through the browser, a request compliant with communication protocol according to the user request (for example, an HTTP Request for the URL of “http://vod.airplug.com/video/movieABC.mp4”) is sent to the operating system 100a. The operating system 100a then transmits the received request compliant with communication protocol through hardware resources (the cellular codec 1b/cellular modem 1a in case a connection is made to the cellular network 11a while the Wi-Fi codec 2b/Wi-Fi modem 2a in case the connection is made to the Wi-Fi network 11b) to support a communication network to which the mobile communication terminal is connected (namely, for which a connection IP address is assigned to the mobile communication terminal) for a current data service. Accordingly, if a response from the content server 12, for example, media data related to the selected data object is duly received through a requested communication network, the response is provided to the browser.

The response received by the browser includes file description information about a data object provided as a response, for example, MIME (Multipurpose Internet Mail Extensions) type and overall size of the data object in addition to the content data transmitted by the content server 12. Therefore, the browser activates the media player 110, an application associated with the MIME type of the received response. The association of the media player 110 can also be made by the file extension rather than the MIME type. Depending on the MIME type or in the case of absence of an associated extension, downloading can be carried out, which involves saving as a file at the time of receiving with respect to the corresponding data object. The browser, when activating the media player 110, delivers the URL which has caused the response or a request compliant with communication protocol created according to the URL, for example, an HTTP Request or RTSP/RTP Request to the media player 110 being activated as a calling argument.

Up to this point, it has been assumed that the process of activating the media player 110 is carried out through a browser commonly used. It should be noted, however, that the media player 110 can be activated by various applications in addition to the browser. In other words, if access information about particular content, for example, URL is selected while an arbitrary application is running, the application can activate the media player 110 by carrying out the same process as done by the aforementioned browser.

In other case, the media player 110 can be activated without involving a parameterized URL or a request compliant with communication protocol; a URL can be received or selected directly through the user interface. Then the data transceiver 112 is notified of the URL received or selected directly or a request compliant with communication protocol according to the URL.

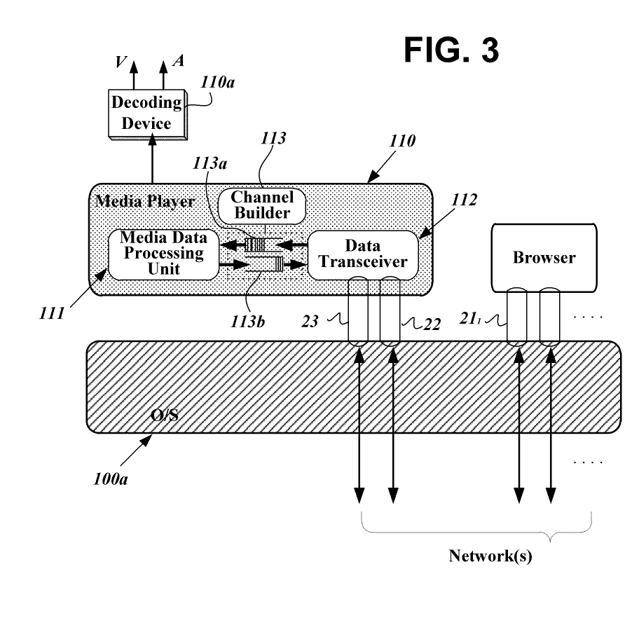

Once the media player 110 is activated, the channel builder 113 allocates the receiving buffer 113a and transmission buffer 113b to the memory 7, and each of the allocated buffers 113a, 113b is shared with the media data processing unit 111 and the data transceiver 112. The data transceiver 112 is notified of the received calling argument; as shown in FIG. 3, while providing the notified calling argument, namely a request compliant with communication protocol, the data transceiver 112 requests the operating system 100a to create a new communication socket 22. At this time, the request can be handled in a communication network currently connected for data services or in a particular communication network. To specify a communication network, the data transceiver 112 references network connection information returned from consulting the operating system 100a. Since the network connection information includes a connection IP address and connection type (for example, 3G mobile phone network and Wi-Fi LAN network) in the event that the mobile communication terminal 100 is being connected to a communication network, creation of a communication socket can be requested by specifying a connection type for a communication network to be used or specifying a connection IP address associated with the communication network.

The operating system 100a confirms a destination IP address of a received request compliant with communication protocol through the information carried by the request (for example, protocol information, name of a host field, or IP address carried by the request), assigns a port number according to the protocol of the request, and specifies IP:Port address (in what follows, the term of “IP address” is also used to denote a port number) of the destination. The operating system 100a, after confirming a local IP address (IP:Port) specified by adding a port number allocated to the data transceiver 112 (depending on the needs, the data transceiver in this context can be replaced with the media player 110) which has requested creation of a communication socket to a connection IP address allocated by a currently connected communication network (in case a communication network is designated but the mobile communication terminal 100 is not connected to the designated communication network, the connection IP address obtained after demanding allocation of a connection IP address with respect to the designated communication network), establishes a TCP connection with the content server 12 by pairing the destination IP address and the local IP address. Once the TCP connection is established successfully, the operating system 100a returns the identifier of a created communication socket 22 to the data transceiver 112 in response to the request for creating a communication socket.

When the identifier of a created communication socket 22 is returned, the data transceiver 112 transmits again the previously notified request compliant with communication protocol to the content server 12 through the communication socket 22 specified by the identifier and receives the response received previously by the browser through the newly created communication socket 22. At this time, the request compliant with communication protocol for transmission, for example, a content request document created according to the HTTP syntax for the URL of “http://vod.airplug.com/video/movieABC.mp4” is stored separately for later use in association with the communication socket 22 which has transmitted the request. Meanwhile, the browser, at the same time the media player 110 is activated, may transmit a request compliant with communication protocol which commands suspension of transmission of response data through the communication socket 21i, through which the corresponding response data are received, or close the communication socket 211.

The data transceiver 112 reads the response data received through the communication socket 22, interprets the response data according to communication protocol, for example, the HTTP or RTSP/RTP protocol, and moves data of a media file streamed according to the response to the receiving buffer 113a in a sequential order. And the data transceiver 112 extracts metadata about content data from the response and stores the metadata separately for later use. The metadata, in addition to the file description information provided according to a protocol format meant for transmission of a media file, includes media information extracted from the front part of a media file data. The media information includes playtime information of content.

The media data processing unit 111 takes out media data accumulated in the receiving buffer 113a in a sequential order through the same method as above, determines a decoding method according to encoding information of data recorded in the header of the data, and decoded the media data partially or completely according to the decoding method determined. In the case of partial decoding, the decoder 110a is also configured with the decoding method determined. The partial decoding may be, for example, extraction of media packets in units of blocks, pictures, or GoP (Group of Pictures). In case the media data are decoded partially as described above, the media data processing unit 111 requests decoding while feeding the decoded media packets to the decoder 110a, thereby outputting an image and audio signal of the decoded media packets. The image data fully decoded by the media data processing unit 111 is applied to the display driving unit 4 through the operating system 100a and output as an image signal.

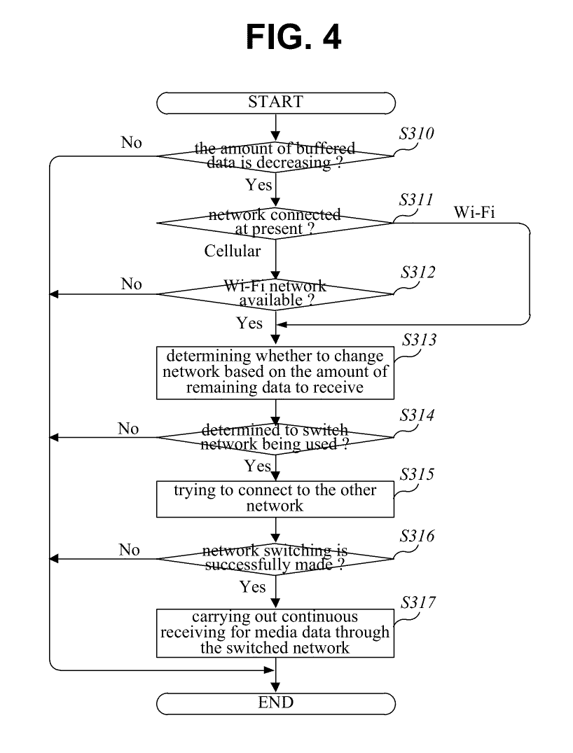

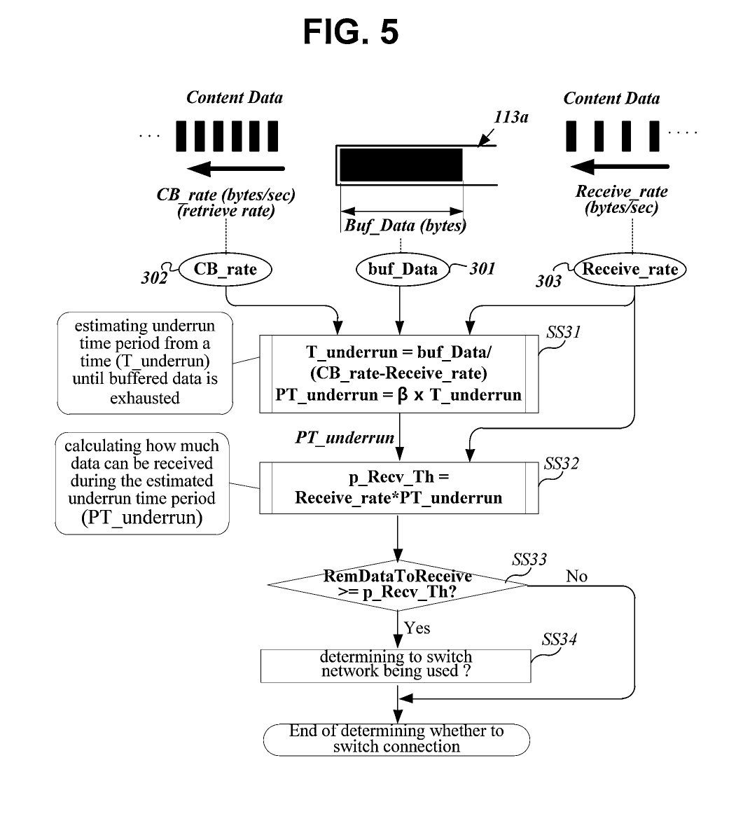

Meanwhile, similar to the description above, in the middle of receiving and decoding media data, the data transceiver 112 continuously monitors the total amount of media data received through the communication socket and moved to the receiving buffer 113a and the amount of unprocessed data not provided to the media data processing unit 111 but accumulated in the receiving buffer 113a, namely the amount of buffered data and change thereof. When a predefined condition is met, the data transceiver 112 carries out a method for controlling network switching while receiving content data as described in FIGS. 4 and 5. The predefined condition can be a predetermined period.

The data transceiver 112, to know whether connection switching is necessary in the middle of receiving streaming data, checks smooth operation of a current communication network, which is one of conditions for connection switching. In one embodiment according to the present invention, smoothness of a communication state can be checked on the basis of a buffering state of the receiving buffer 113a, S310. In other words, if the amount of buffered data is decreasing, it can be determined that the current communication network is in a poor condition whereas the current network is regarded to be in a good condition of communication in the opposite situation. If a current state corresponds to the condition for connection switching, namely, if the buffering state indicates a decrease of the amount of buffered data (for example, the amount of buffered data currently checked is smaller than the amount of buffered data checked previously by more than a predetermined limit), the data transceiver 112 checks a current access network S311. As described earlier, checking of an access network is carried out by using network access information obtained through an inquiry about the operating system 100a. If a current access network is a cellular network 11a, the data transceiver 112 checks whether a different network, the Wi-Fi network 11b, is available S312 and determines whether to switch the network being used based on the amount of remaining data to receive S313. If a current access network is the Wi-Fi network 11b, the data transceiver 112 directly determines S313 whether to switch the network being used based on the amount of unreceived data without checking availability of the cellular network 11a, which is now a different communication network. The data transceiver 112 operates as described above since the cellular network usually provides a broad service area and thus can be connected to mobile communication terminals regardless of their current location.

To check availability of the Wi-Fi network 11b, the data transceiver 112 requests the operating system 100a to send information about the state of the Wi-Fi network and receives the information. The operating system 100a, in response to the request, controls the Wi-Fi modem 2a to physically search a Wi-Fi signal band for a valid signal. The operating system 100a then reads identification information of each access point (AP) and RSSI (Received Signal Strength Indicator) thereof provided when the Wi-Fi modem 2a detects a valid signal in the corresponding signal band and returns them to the data transceiver 112. If the returned information does not carry information about access points, the data transceiver 112 determines that a current Wi-Fi network is not available. If the information contains no access point which exhibits signal power stronger than predetermined strength, that case also indicates that the current Wi-Fi network is unavailable.

Determination of whether to switch a communication network according to the amount of remaining data of streaming content is carried out immediately in case the current access network is the Wi-Fi network 11b, but only when the Wi-Fi network is available in the case of the cellular network 11a. This conditional operation will be descried in detail with reference to the flow diagram of FIG. 5.

The data transceiver 112 checks the amount of buffered data buf_Data 301 still remaining in the receiving buffer 113a and not provided to the media data processing unit 111 yet, a data withdrawal rate CB_rate 302 (or the rate at which data are provided to the media data processing unit 111) from the receiving buffer 113a by the media data processing unit 111, and a data receiving speed (Receive_rate) 303 at which data are received through a communication socket from the operating system 100a. The data withdrawal rate 302 corresponds to a bit rate required for playing the corresponding content, which can be obtained by dividing the total size TD_size of the content data included in the aforementioned metadata with play time of the content P_Time, namely C_BR=TD_Size/P_Time. And the data receiving speed 303 can be known from the amount of data moved to the receiving buffer 113a through a communication socket for a predetermine time period.

Once the aforementioned elements 301, 302, 303 are identified, the data transceiver 112 estimates underrun (data exhaustion) time PT_underrun of the receiving buffer 113a SS31. While the amount of buffered data is decreasing, the data withdrawal rate CB_rate is faster than the receiving speed Receive_rate; therefore, as illustrated in the figure, Division of the current amount of buffered data buf_Data 301 by a reduction rate (CB_rate−Receive_rate) gives the time T_underrun required up to the underrun time at which the current amount of buffered data is exhausted. The estimated underrun time PT_underrun is obtained by multiplying the time T_underrun with an appropriate compensation coefficient β (for example, a real number larger than 1.0). Once the estimated underrun time is obtained, the data transceiver 112 calculates SS32 an estimated reference amount of data to be received p_Recv_Th that can be received at a current receiving speed Receive_rate during the estimated underrun time period. As shown in the figure, the estimated reference amount of data to be received p_Recv_Th is obtained by multiplying a current receiving speed Receive_rate with the estimated underrun time PT_underrun estimated. The estimated reference amount of data to be received p_Recv_Th obtained as described above is proportional respectively to the receiving speed Receive_rate and the amount of buffered data buf_Data and inversely proportional to the withdrawal rate CB_rate. The estimated reference amount of data to be received p_Recv_Th is last compared SS33 with the amount of remaining data to receive RemDataToReceive of the previously selected content data. The amount of remaining data to receive is obtained by subtracting the total amount of content data received up to the current time through the receiving buffer 113a from the total amount of content data specified in the previously stored metadata. If the amount of remaining data to receive is larger than the estimated reference amount of data to be received p_Recv_Th, which is a reference value for the amount of remaining data used to determine whether to carry out network switching, the data transceiver 112 determines switching of communication networks SS34. If the amount of remaining data to receive is smaller than the estimated reference amount of data to be received p_Recv_Th, the data transceiver 112 determines to retain using a current communication network without network switching even if the current amount of buffered data is decreasing.

In one embodiment according to the present invention, a reference value for the amount of remaining data can be set differently according to an additional condition when the current state satisfies a condition for connection switching. For example, the reference value for the amount of remaining data determined above can be made larger (in case the amount of remaining data is very large) or smaller (for example, in case the amount of remaining data is small) according to the amount of remaining data to receive. The additional condition can include a condition for establishing a connection, for example, characteristics of a communication network, and according to the condition, a new reference value adjusted from the reference value for the amount of remaining data determined previously can be used for determining whether to switch a communication network. More detailed descriptions thereof will be provided later.

Since a communication state is inherently dynamic, there is the chance that a receiving speed changes after the determination of connection switching and drops below the receiving speed at the time of the determination. Therefore, since underrun of the receiving buffer 113a can occur in case a connection to the current communication network is retained as it is decided not to perform connection switching, a margin can be introduced in the comparison step SS33 with the estimated reference amount of data to be received p_Recv_Th. For example, if the amount of remaining data to receive RemDataToReceive is smaller than the size obtained by subtracting a predetermined margin from the estimated reference amount of data to be received p_Recv_Th, it can be decided not to perform switching communication networks.

In another embodiment according to the present invention, the estimated underrun time PT_underrun may use a value obtained by dividing the current amount of buffered data buf_Data by the withdrawal rate CB_rate only. The present embodiment can also be applied to the case where the amount of buffered data is increasing as the receiving speed Receive_rate is faster than the withdrawal rate CB_rate. In other words, the present embodiment can also be applied to an embodiment from which the step of S310 of the flow diagram illustrated in FIG. 4 is excluded. Moreover, the present embodiment can be applied to the case where the current state corresponds to a different condition specified for connection switching described below and thus a reference value for the amount of remaining data for connection switching is determined.

In the embodiment described above, the estimated reference amount of data to be received p_Recv_Th and the amount of remaining data to receive RemDataToReceive have been compared with each other SS33. In another embodiment according to the present invention, however, the estimated underrun time PT_underrun obtained by the aforementioned method can be used as a reference value for the amount of remaining data to determine whether to switch the network being used. In other words, estimated time to complete data reception T_Recv_Complete for the amount of remaining data to receive can be calculated and used for comparison with the estimated underrun time PT_underrun. In the present embodiment, the estimated time to complete data reception T_Recv_Complete can be obtained by dividing the amount of remaining data to received RemDataToReceive by the current receiving speed Receive_rate. If the estimated time to complete data reception T_Recv_Complete is equal to or larger than the estimated underrun time PT_underrun, it is determined to perform connection switching of communication networks whereas a connection to the current network is retained in the opposite case.

As described above, if there is a sufficient chance as expected from the current state that the remaining data can be received without underrun even when discontinuity during playing of content data may occur due to buffer underrun as the amount of buffered data is reduced, the embodiment described above does not bring about unnecessary operation of switching communication networks and subsequent consumption of communication resources by retaining a connection to the current communication network.

If the connection switching decision step illustrated in FIG. 5 S313 determines to perform switching of the communication network being used S314, the data transceiver 112 carries out connection switching to the other communication network S315. For example, the data transceiver 112 attempts to switch to a Wi-Fi network in case a cellular network is the current communication network, and vice versa. In the case of switching to the Wi-Fi network 11b, if a plurality of access points, found at the previous availability checking step S313, are available, the data transceiver 112 selects the access point with the highest signal strength and requests the operating system 100a to connect to the corresponding access point. The connection switching can be carried out by designating a communication network and demanding a connection with respect thereto or by demanding activation or deactivation of the Wi-Fi network. In the latter case, at the time of demanding activation of the Wi-Fi network, a connection IP address allocated by the operating system 100a from the cellular network 11a is released, but a new connection IP address is assigned from the Wi-Fi network 11b. At the time of demanding deactivation of the Wi-Fi network, a connection IP address allocated from the Wi-Fi network 11b is released and a new connection IP address is allocated from the cellular network 11a.

If connection networks are switched between the cellular network 11a and the Wi-Fi network 11b according to the request for connection switching to the other communication network S316, in other words, if a connection IP address is changed as a new connection IP address is allocated from the communication network attempted for connection, the data transceiver 112 carries out continuous reception of media data through the following procedure S317.

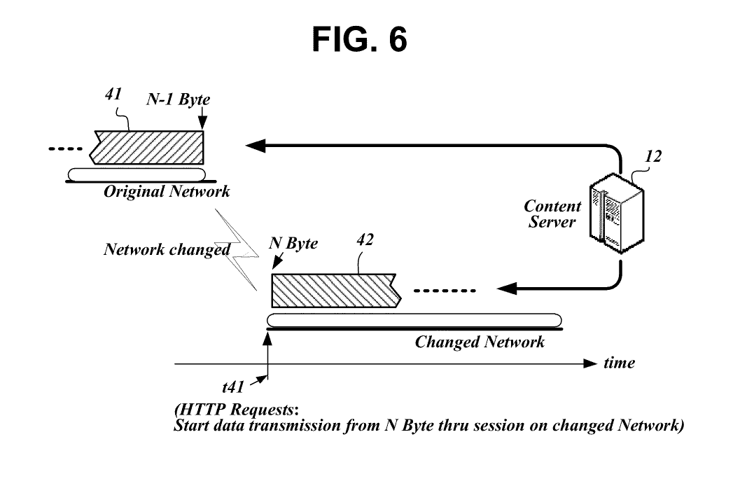

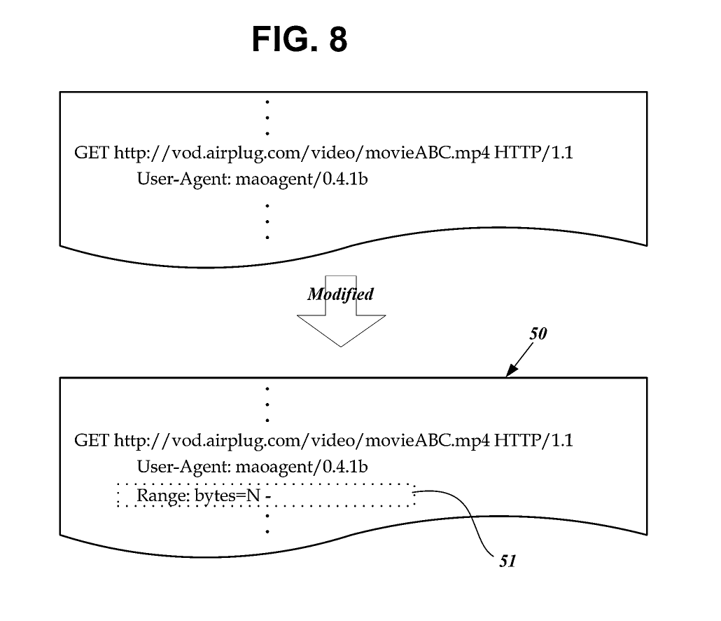

First, the data transceiver 112, based on the information specified in a request document created according to a previously stored request compliant with communication protocol in association with the communication socket 22, for example, syntax describing a URL such as “http://vod.airplug.com/video/movieABD.mp4”, supposed to be closed by the connection switching, newly creates a communication socket (23 of FIG. 3). At this time, the communication socket is intended for a TCP connection which enables communication with the content server 12 through the cellular network 11a or the Wi-Fi network 11b currently connected by the connection switching (afterwards, it is called collectively a “communication network after connection switching”). Through the communication socket 23 created, the data transceiver 112 updates the stored request compliant with communication protocol to reflect the total amount of media data moved to the receiving buffer 113a so far and transmits the updated request. For example, as shown in FIG. 6, if the total amount of media data moved to the receiving buffer 113a is ‘N−1’ byte 41, the data transceiver 112 transmits an HTTP Request 50 updated by incorporating a range field 51 into the request compliant with communication protocol demanding the corresponding content data from the N bytes, for example, the HTTP Request previously transmitted as illustrated in FIG. 8 and transmits the updated HTTP Request 50 through the newly created communication socket 23 t41.

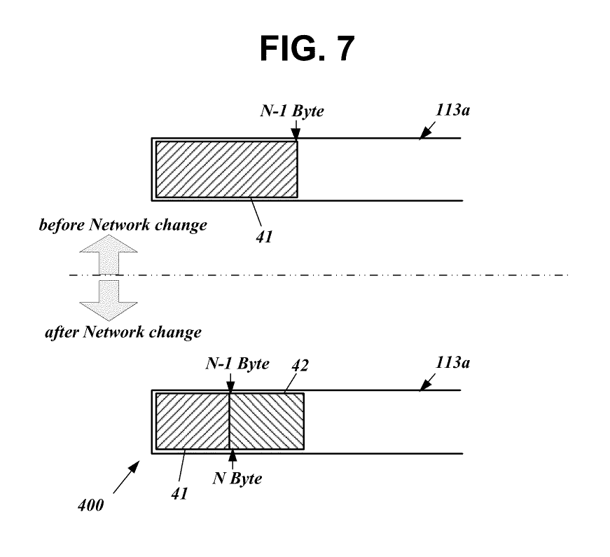

Accordingly, the content server 12 transmits the same content transmitted to the mobile communication terminal 100 from the N byte 42 through the communication network after connection switching. The media data, after being received by the cellular modem 1a and cellular codec 1b (in case the communication network after connection switching corresponds to the cellular network 11a) or the Wi-Fi modem 2a and Wi-Fi codec 2b (in case the communication network after connection switching corresponds to the Wi-Fi network 11b), delivered to the data transceiver 112 through the newly created communication socket 23 by the operating system 100a. The data transceiver 112 then stores 400 the media data 42 received according to the aforementioned manner in the receiving buffer 113a subsequent to the previously received media data 41 as shown in FIG. 7. By doing so, the data transceiver 112 ensures continuity of media data, which are then provided to the media data processing unit 111. Therefore, the media data processing unit 111 is enabled to decode media data stored in the receiving buffer 113a in its original order and provide seamless video and audio continuously to the user without causing suspension or discontinuity of playing media data in the case of connection switching of communication networks.

Meanwhile, if a current communication network is in a good condition; the amount of buffered data in the receiving buffer 113a is not decreasing; a Wi-Fi network 11b is not currently available; network switching is not chosen, or allocation of a connection IP address fails in spite of an attempt of connecting to a different communication network, the data transceiver 112 maintains receiving of media data through a currently connected communication network.

In the previous embodiment, each time a predefined condition is met, for example, the state of a communication network (for example, whether the amount of buffered data in the receiving buffer 113a is decreasing), which is one of conditions for connection switching, is checked at each period and based on the checking result about the amount of remaining data to receive, network switching is determined.

In other embodiments according to the present invention, in addition to the condition that the aforementioned communication network is in a poor state, if the current state of the network corresponds to another condition for connection switching, the connection switching according to the amount of remaining data to receive can be decided; in what follows, embodiments related to the aforementioned situation will be described.

In one embodiment according to the present invention, while a mobile communication terminal 100 is currently connected to the cellular network 11a, if the Wi-Fi network 11b becomes available to the mobile communication terminal 100 as it moves to a service area thereof, which causes no costs in using a data service or relatively small costs compared with the cellular network 11b, connection switching can be determined. If the mobile communication terminal 100 is configured to be active for connection to a Wi-Fi network while the cellular network 11a is the currently connected network, the operating system 100a notifies the data transceiver 112 about availability of a Wi-Fi network, and according to the notification, the data transceiver 112 determines whether to perform switching between communication networks. In other words, as described in the previous embodiments, if the amount of remaining data is expected to be received completely during estimated underrun time period PT_underrun of the receiving buffer 113a, in other words, if the amount of remaining data to receive (or estimated time to receive the amount of remaining data) is smaller than a predetermined reference value for the amount of remaining data (time or data size) or the amount of remaining data to receive is smaller than a reference value for the amount of remaining data determined by a different parameter described below, connection switching to the Wi-Fi network which has become available is not carried out. On the other hand, if the amount of remaining data to receive is larger the reference value, switching to the Wi-Fi network is carried out.

In general, the Wi-Fi network 11b, providing scattered, local service areas, is made available additionally while a mobile communication network is connected to the cellular network 11a providing a broad service area. In this case, if connection switching is made to the Wi-Fi network 11b without checking of a data object currently received, for example, without checking the amount of remaining data to receive, benefits gained from the connection switching (for example, cost reduction, communication speed enhancement, and so on) may be insignificant but disadvantages such as discontinuity in playing content data and delayed reception of the content data due to the time required for connection switching may grow to be significant. This tendency becomes more outstanding due to the uncertainty that the actual communication state of the Wi-Fi network 11b can be known only after connection to an access point of the corresponding network is established. Therefore, in case there is a high chance estimated from a current state that the amount of remaining data can be received completely without suffering underrun or in case the amount of remaining data is less than the reference value for the amount of remaining data determined by another parameter, which is described below, the current connection to the cellular network 11a is retained so that unnecessary operation for connection switching and consumption of communication resources due to the operation can be avoided and a possibility of occurrence of disadvantages described above can be prevented at the same time.

In another embodiment according to the present invention, even when the operating system 100a notifies that a communication network with service characteristics or service quality better than those provided by the current communication is newly available among communication networks that can be communicated through hardware/software resources of the mobile communication terminal 100, network switching is determined by comparing a predetermined reference value with the amount of remaining data as described above, and network switching can be performed selectively according to the determination. Suppose a Wi-Fi network is the currently connected network and a notification is received that a communication network providing better service quality than the current receiving speed on an average, for example, a 4G communication network has become available, the data transceiver 112, as in the embodiments above, may or may not switch to the 4G communication network depending on a decision about whether the amount of remaining data can be received completely within the estimated underrun time PT_underrun or whether the amount of remaining data is less than a reference value for the amount of remaining data determined by another variable described later.

In the embodiments described above, the estimated underrun time PT_underrun or the reference value for the amount of data to receive during the estimated underrun time period p_Recv_Th were used as a reference value for the amount of remaining data; however, other variables can be used as the reference value for the amount of remaining data in other embodiments according to the present invention. The time required for the mobile communication terminal 100 to switch communication networks can be an example of the reference value for the amount of remaining data. In one embodiment according to the present invention, the reference value for the amount of remaining data is determined to be the value obtained from multiplication of the time required for switching communication networks Tₜᵣₐₙₛ with a variable coefficient α (which can be a value ranging, for example, from 1.0 to 2.0) (=α×Tₜᵣₐₙₛ) or the time assigned to a time interval to which the switching time belongs. For example, in the former case, if the time required for switching communication networks is set to 5, 7, or 10 seconds, the reference value for the amount of remaining data is determined to be 7.5, 10.5, or 15 seconds when the variable coefficient is 1.5. In the latter case, if the time required for switching communication networks is less than 4 seconds, the reference value for the amount of remaining data is determined to be 4 seconds; in the case of a time interval ranging from 4 to 8 seconds, 8 seconds; and in the case of a time interval ranging from 8 to 16 seconds, 16 seconds. It should be noted that the reference value for the amount of remaining data can be determined based on the time required for switching communication networks Tₜᵣₐₙₛ in various other ways. The switching time Tₜᵣₐₙₛ can be determined as an average value of time records belonging to a predetermined time period for a current switching target from among time records collected and stored by measuring the time required for the data transceiver 112 to perform connection switching of communication networks for each switching target (for example, switching from a cellular network to each access point of a Wi-Fi network or switching in the opposite direction, or switching between access points of the Wi-Fi network) or can be determined for the current switching target from connection information about an adjacent communication network received from a particular external server. Also, the switching time can be determined for a current switching type from the switching time defined differently according to the type of connection switching (switching from the cellular network to the Wi-Fi network, switching from the Wi-Fi network to the cellular network, or switching between APs of the Wi-Fi network). After the switching time is determined on the basis of the connection switching time, the data transceiver 112 compares the determined reference value for the amount of remaining data with the amount of remaining data to receive when whether to perform connection switching needs to be determined as the specified condition for connection switching is met as described above. In the comparison process, the values are converted to the same physical units for comparison. As described above, the reference amount obtained by multiplication of the determined reference value with a current average receiving rate or an average receiving rate for a predetermined time period Receive_rate is compared with the amount of remaining data to receive RemDataToReceive. Similarly, the amount of remaining data to receive RemDataToReceive divided by the current average receiving rate or the average receiving rate for a predetermined time period is compared with the determined reference value. If the amount of remaining data to receive is less than the reference for the amount of remaining data, the data transceiver 112 does not perform connection switching between communication networks as described above.

As another example of the reference value for the amount of remaining data, a reception time limit about the previously selected content can be used. The reception time limit can be defined as the remaining time within a time limit set by the user or the remaining time calculated by predetermined limit time. For example, the reception time limit can be obtained by subtracting the time consumed for receiving data of the selected content from the time limit set by the user (for example, 1, 2, or 5 hours), by which complete reception of the selected content is desired. Likewise, the reception time limit can be defined by the remaining time measured at the present time until the limit time at which reception of the selected content is desired to be completed (for example, AM 9:00 or PM 6:00). The desired limit time or time limit is input or selected through a selection window provided on the display panel 5 in an appropriate form at the time of initialization of the media player 110 or at the time of selecting new content. The desired limit time or time limit input or selected through the selection window is received by the media player 110 through the input control unit 6 and shared by the data transceiver 112. The data transceiver 112 measures the time elapsed since initial response data are received according to a transmitted request compliant with communication protocol and calculates the reception time limit by subtracting the measured elapsed time from a predetermined time limit. Similarly, the data transceiver 112 may check the current time point from the operating system 100a and calculate the remaining time from the current time until the limit time, thereby calculating the reception time limit. If the reception time limit is calculated as described above, the data transceiver 112 uses the calculated reception time limit as the reference value for the amount of remaining data, converts the reference value into the same physical units as described above, and compares the converted value with the amount of remaining data to receive. If the amount of remaining data to receive is smaller than the reference value, namely, if the amount of remaining data to receive is expected to be received completely within a time limit or before the limit time set by the user, the data transceiver 112 does not perform connection switching between communication networks as described above.

In the process of the embodiments described above for converting a reference for the amount of remaining data and the amount of remaining data to receive into the same physical units for comparison between the two, a current receiving speed is reflected into either of the reference value for the amount of remaining data and the amount of remaining data to receive to determine the relative size between the two quantities. In other words, if the receiving speed is fast, the reference value for the amount of remaining data gets relatively larger during the comparison (or the amount of remaining data to receive gets relatively smaller) while, if the receiving speed is slow, the reference value gets relatively smaller (or the amount of remaining data to receive gets relatively larger). As the receiving speed approaches 0, the reference value also takes on a value close to 0 (where the relative size with respect to the amount of remaining data to receive also gets close to 0) during the comparison process, or the amount of remaining data to receive approaches infinity (where the relative size of the reference value for the amount of remaining data with respect to the amount of remaining data to receive approaches 0). Therefore, in the embodiments above, a reference value for connection switching is determined relatively according to the receiving state of a current communication network. For example, if a receiving speed becomes smaller than before, the relative size of the reference value for the amount of remaining data with respect to the amount of remaining data to receive is reduced more than before and as such, applied to the comparison process.

Meanwhile, the reference value for the amount of remaining data (the estimated reference amount of data to be received p_Recv_Th, the estimated underrun time PT_underrun, time required for connection switching, or the reception time limit) determined by the method described above can be adjusted according to various conditions or states, which will be described in detail below.

The data transceiver 112 adjusts the reference value for the amount of remaining data determined by one of the embodiments above according to the mode with respect to a communication network use policy and then compares the reference value with the amount of remaining data to receive RemDataToReceive (or estimated reception time for the amount of remaining data to receive). To describe the aforementioned operation, the mode with respect to a communication network use policy set to the mobile communication terminal 100 will be described first.

Various types of mobile communication networks utilizing different infrastructures apply different communication service rate schedules to the users depending on service provision policies of the respective service providers. For example, a data service based on a cellular network usually assumes a default amount of data within a standard rate schedule and charges additional costs in case the amount of data used exceeds the default amount of data, and the data service is provided free of charge in the case of using a Wi-Fi network. Therefore, in case the cellular network 11a, which guarantees relatively sufficient consistency of data services, is used continuously, the user may be charged an additional rate besides the standard rate depending on a rate schedule to which the user has subscribed.

In this regard, in an embodiment according to the present invention, special modes are defined, which are used to specify which aspect is given a more weight between incurrence of cost due to using a data service and availability of the data service in selecting a communication network for using a data service. Included in the modes are an “economic mode” meant to restrain incurrence of additional cost, “convenience mode” which puts a high priority on the user convenience, for example, availability of a data service, and “standard mode” compromising restraint of cost incurrence and user convenience. The media player 110 suggests the illustrated modes through a user interface of the mobile communication terminal 100 at the time of the initialization or selecting new content and receives one mode selected by the user and notifies the data transceiver 112 about the selected mode.

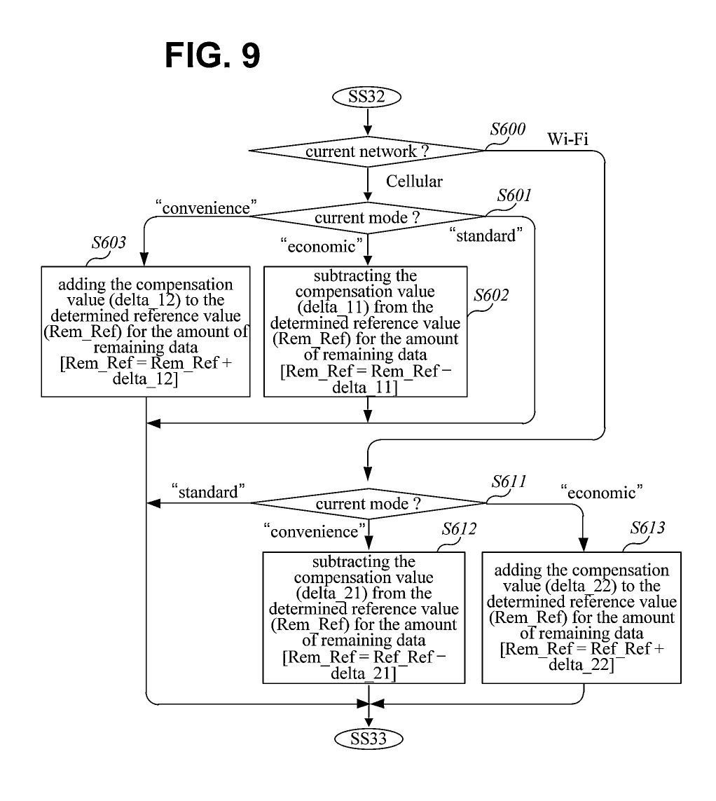

The data transceiver 112 selectively adjusts the previously determined reference value for the amount of remaining data based on the notified mode and a currently connected network, the procedure of which is illustrated in FIG. 9. If a current communication network is the cellular network 11a, S600 and the notified mode is “economic mode” S601, a predetermined compensation value delta_11 is subtracted from the previously determined reference value for the amount of remaining data S602. In case the current mode is “economic mode”, which indicates that the user counts restraint of an incurred cost more heavily than availability of a data service, the reference value for the amount of remaining data meant for connection switching is lowered so that connection switching to the Wi-Fi network 11b can be carried out even if the amount of remaining content data is less than the reference value before adjustment thereof. In case the amount of remaining data is smaller than the reference value after the adjustment, the communication network in use will be retained until the amount of remaining data is received through the cellular network 11a. If the current mode is “convenience mode” S601, which indicates that the user counts availability of a data service more heavily than restraint of an incurred cost due to using the data service, the predetermined compensation value delta_12 is added S603 to the previously determined reference value for the amount of remaining data so that the current cellular network 11a can be used continuously even if the amount of remaining data exceeds the reference value before the adjustment. If the current mode is “standard mode” S601, compensation for the previously determined reference value for the amount of remaining data is not carried out.

If the current communication network corresponds to the Wi-Fi network 11b, S600 and the notified mode is “convenience mode” S611, the data transceiver 112 subtracts the predetermined compensation value delta_2 from the previously determined reference for the amount of remaining data S612. If the current mode is “convenience mode”, the reference for the amount of remaining data, which functions as a criterion for connection switching, is reduced so that connection switching to the cellular network 11a, exhibiting relatively stable service characteristics, can be carried out even if the amount of remaining content data is smaller than the reference amount before the adjustment. If the current mode is “economic mode” S611, the predetermined compensation value delta_22 is added S613 to the previously determined reference value for the amount of remaining data so that the current Wi-Fi network 11b can be used continuously even if the amount of remaining data is larger than the reference value before the adjustment. If the current mode is “standard mode” S611, compensation for the previously determined reference value for the amount of remaining data is not carried out.

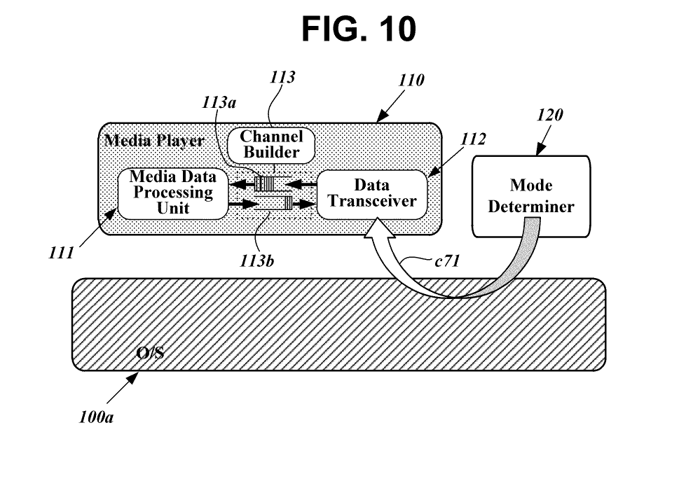

In another embodiment according to the present invention, the media player 110, instead of receiving mode configuration from the user, can read the mode assigned by a different application or process. FIG. 10 illustrates a structure related to the present embodiment; the mode determiner 120 provides the user with a menu meant for determining a mode as described above, for example, at the time screen lock of the mobile communication terminal 100 is released or at the time the user makes a request for execution; and stores the mode configured through the aforementioned process. The mode determiner 120 can help the user easily determine which mode is appropriate at a particular time point by presenting at least data usage through the cellular network 11a and remaining days (or passed days) in terms of a rate schedule period together when the menu is provided. The stored mode value is shared by the data transceiver 112 as the media player 110 receives the mode value by demanding the mode determiner 120 to send the mode value at the time of initialization. Acquisition c71 of the mode value from the mode determiner 120 can be carried out though a channel, which is established by the media player 110 by demanding the operating system 100a to establish the channel in conjunction with an application or process with a predetermined identifier.

The mode determiner 120 can also determine the mode automatically according to data usage for each communication network. To this end, the mode determiner 120 periodically checks the data usage monitored by the operating system 100a and figures out through the checked data usage the amount of transmitted and received data for each interval and each communication network according to a rate schedule of the user, for example, the amount of transmitted and received data used through the cellular network 11a. Also, the mode determiner 120 checks, based on a rate schedule configured for the communication network by the user, checks the default amount of data over which additional expense is caused and determines the amount of remaining data by deducting the checked amount of data used (comprising the amount of transmitted and received data) from the default amount of data. The mode determiner 120 then calculates a ratio of the default amount of data to the amount of remaining data rd_r and ratio of the remaining time period, for example, the ratio of the total number of days configured for the rate schedule to the number of days currently remaining rt_r; calculates the remainder ratio (rr=rd_r/rt_r) from the two calculated ratios; and determines the mode automatically based on the value of the remainder ratio rr. For example, the remainder ratio rr is less than 0.5, the mode determiner 120 determines the mode as “economic mode”; in case the remainder ratio is 1.5 or above, the mode is determined to be “convenience mode” while, if the remainder ratio is larger than 0.5 and less than 1.5, the mode is determined to be “standard mode”. In one embodiment according to the present invention, the mode determiner 120 can be incorporated into the media player 110 in the form of a sub-process or can be implemented as a separate application. In the latter case, the mode determiner 120 is activated automatically and determines one from among the aforementioned modes when a particular condition is met, for example, when the screen lock of the mobile communication terminal 100 is released or when another application requests mode information. The determined mode can be notified through a channel established between processes through the operating system 100a as described above.

In one embodiment according to the present invention, the reference value for the amount of remaining data can be set differently according to the type of connection switching. For example, provided that the determination of the reference value for the amount of remaining data is based on a particular type of connection switching by default, for example, connection switching between access points within a Wi-Fi network described below, the reference value for the amount of remaining data is adjusted to be smaller than that for the default type if the switching type is such that connection switching is carried out from the cellular network to the Wi-Fi network. If the switching type is such that connection switching is carried out from the Wi-Fi network to the cellular network, the reference value is adjusted to be larger than that for the default type. In other words, the reference value for the amount of remaining data is set so that connection switching from the cellular network 11a, which on average charges the user a large cost for using a data service, to the Wi-Fi network 11b can be carried out even when the amount of remaining data is larger than that set for connection switching in the opposite direction. Meanwhile, when a different type of connection switching is used as the base type of connection switching, the reference value for the amount of remaining data can be adjusted for the different type of connection switching so that it has relative magnitude for each switching type as in the previous example. If the average cost charged on the user is the same both for using the cellular network 11a and the Wi-Fi network 11b, the present embodiment and the previous embodiment where the reference value for the amount of remaining data due to time required for connection switching is set differently according to the type of connection switching may not be carried out at the same time. However, if the two communication networks 11a, 11b charge the user differently for using the respective networks, the present invention and the previous embodiment where the reference value for the amount of remaining data due to time required for connection switching is set differently according to the type of connection switching may be carried out at the same time.

The above embodiment where the reference value for the amount of remaining data is adjusted according to the type of connection switching can be combined in series with the embodiment described above, where the reference value is adjusted according to the mode. For example, the reference value for the amount of remaining data can be adjusted first according to the type of connection switching, and the firstly adjusted reference value can be fine-tuned in a second stage according to a current mode checked as described with respect to FIG. 9 as a compensation vale is added to or subtracted from the firstly adjusted reference value.

In one embodiment according to the present invention, the determined reference value for the amount of remaining data can be adjusted according to the state or communication characteristics of a network in use. For example, if the Wi-Fi network 11b is currently in use, the data transceiver 112 checks current RSSI (Received Signal Strength Indicator) of an access point connected through the operating system 100a, compares the RSSI with a previous value, and calculates a variation range. If the variation range is larger than a predetermined limit, the data transceiver 112 reduces the determined reference value for the amount of remaining data by a predetermined compensation value or by the value in proportion to a difference between the variation range and the variation limit. In this manner, the reference value for the amount of remaining data meant for connection switching is reduced to make connection switching carried out to the cellular network 11a as possibly as can be done unless the amount of remaining data is the minimum amount (the reference value for the reduced amount of remaining data) since an increased variation may have been caused by relative instability of the currently employed Wi-Fi network, for example, movement of the mobile communication terminal 100 or a currently connected access point, which deteriorates communication quality significantly.

In another embodiment according to the present invention, instead of variation of a signal strength value, variation of the monitored receiving speed may be used. In other words, if the variation between a current receiving speed and the previously checked one exceeds a predetermined limit, the determined reference value for the amount of remaining data is reduced by a predetermined compensation value or by the value in proportion to a difference between the variation range and the variation limit. The present embodiment can be applied irrespective of whether a current network corresponds to the cellular network 11a or the Wi-Fi network 11b. It should be noted, however, that in case the current network corresponds to the cellular network 11a, availability of the Wi-Fi network 11b is first checked and the determined reference value for the amount of remaining data can be adjusted only if the Wi-Fi network 11b is available.

In one embodiment according to the present invention, the reference value for the amount of remaining data can be adjusted according to communication characteristics of a target communication network of connection switching. For example, if the Wi-Fi network 11b, which is a target communication network of connection switching, is made available while the cellular network 11a is currently used, the data transceiver 112 checks communication characteristics for access points of the Wi-Fi network 11b. The communication characteristics can be checked from the RSSI value of the corresponding access point or an estimated transmission speed of the corresponding access point received from an external server. In the former case, the communication characteristics can be checked from a transmission speed estimated based on the information about previous communication state obtained in addition to the RSSI value. If the communication characteristics checked according to the above method, for example, the RSSI value or transmission speed is larger than an appropriate reference value, the data transceiver 112 reduces the reference value for the amount of remaining data accordingly, thereby enabling connection switching to be carried out from a current communication network to another one even when the amount of remaining data is smaller than the reference value before adjustment (or larger than the reference value after adjustment).

In one embodiment according to the present invention, the reference value for the amount of remaining data can be adjusted according to variation of communication characteristics of a target communication network of connection switching. If variation of a value representing communication characteristics checked in the immediately preceding embodiment is larger than the previously checked value representing communication characteristics above a predetermined value, the reference value for the amount of remaining data is increased accordingly. High variation of communication characteristics indicates a lack of stability of a data service in the corresponding communication network after connection switching thereto. Therefore, by increasing the reference value, data reception through the current communication network can be carried out continuously without performing connection switching which increases uncertainty even when the amount of remaining data is larger than the reference value (or smaller than the reference value) before adjustment.

In one embodiment according to the present invention, the reference value for the amount of remaining data can be adjusted according to the reception time limit described earlier. For example, if the Wi-Fi network 11b is a currently connected network and a current reception time limit is greater than a reference time limit determined dynamically by more than a predetermined ratio (for example, 3.0 or 4.0), the data transceiver 112 attempts to increase the reference value for the amount of remaining data according to the ratio or the difference between the two limit values. Due to high variation of a Wi-Fi network, the receiving speed through the Wi-Fi network shows a large fluctuation. Thus, since the value determined by the reference value for the amount of remaining data applied to a comparison process (for example, SS33 of FIG. 5) based on the amount of remaining data (the value converted into the same physical units for comparison with the amount of remaining data to receive) or the value according to the amount of remaining data to receive also fluctuates much, the reference value for the amount of remaining data determined for a short time period can be made relatively smaller than the amount of remaining data to receive, thereby making the data transceiver 112 to determine connection switching to the cellular network 11a. Therefore, in case a current reception time limit is larger than the reference time limit determined dynamically, the reference value for the amount of remaining data is set to a larger value to prevent connection switching to the cellular network 11a, which charges the user a large cost for using a data service, by such an instantaneous condition. If the current reception time limit is smaller than the dynamic reference time limit by less than a predetermined ratio (for example, 1.5 or 2.0), the reference value for the amount of remaining data is reduced according to the ratio or the difference between the two limit values. This adjustment is intended so that connection switching to the cellular network 11a exhibiting relatively stable communication quality can be determined quickly even in the case of an instantaneous change of the communication condition as there is no enough time left before the time limit. In the present embodiment, the dynamic reference time limit is obtained from multiplication of the amount of remaining data to receive divided by the transmission speed of a currently connected network with an appropriate compensation constant. Regarding the transmission speed of the currently connected network, a conventional transmission speed known to be provided from the corresponding communication network can be used. In case data reception has been performed for more than a predetermined time period, an average receiving speed during the time period can be used as the transmission speed of the currently connected network. Similarly, a current transmission speed of the corresponding communication network (or the corresponding access point) obtained from a particular external server or a statistically predicted transmission speed may be used as the transmission speed of the currently connected network.

If the cellular network 11a is the currently connected network, adjustment of the reference value for the amount of remaining data can be carried out in the opposite way as described above. In other words, in case a current reception time limit is larger than the dynamic reference time limit, the reference value for the amount of remaining data is reduced according to the ratio or the difference between the two limit values. Otherwise, the reference value for the amount of remaining data can be increased. This is intended to increase or decrease availability of the Wi-Fi network 11b, which shows advantages in terms of a cost, by taking account of the time left before the time limit.

Various methods for adjusting the reference value for the amount of remaining data described in the previous embodiments can be selected appropriately and implemented together with each other unless they are incompatible with each other.

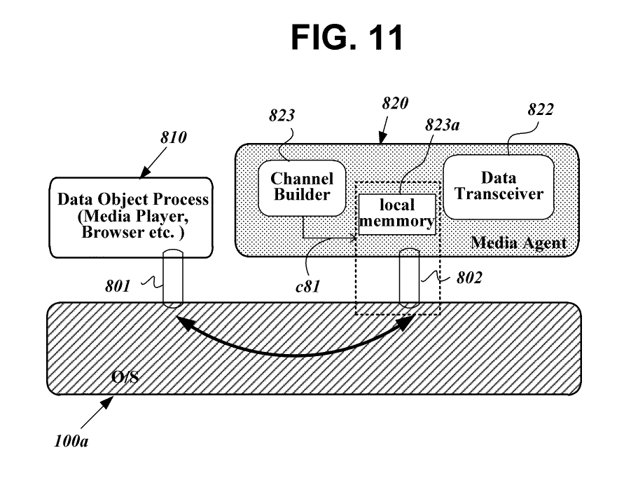

The embodiments described above assume that the data transceiver 112 and the channel builder 113 are implemented in an application for playing content, for example, a means such as a player. In another embodiment according to the present invention, however, as shown in FIG. 11, the data transceiver 822 and the channel builder 823 can be included in a media agent 820 realized in the form of an execution object separately from an applet run by a media player, browser, game application, and other application, for example. In case the data object to be processed is a video or audio media, the data object processor 810 may use the decoder 110a, which is a hardware resource of the mobile communication terminal 100, for decoding of input content data in the same way as the media data processing unit 111 or may store the data object as a separate file without decoding of the data object. Also, in case the data object to be processed is a program or data, the data object processor 810 may execute the input program or store the input data as a file.

The media agent 820 performs an intended function as the main controller 10 executes command codes corresponding thereto and can be implemented in the form of an independent application, middleware, or platform. As described earlier, the media agent 820 can include hardware components as its constituting elements. In the present embodiment, the channel builder 823 forms c81 a local memory 823a and an internal socket 802 to be used together as a data channel for transmitting data of a data object to the data object processor 810. In other words, the channel builder 823 allocates a storage space that can be accessed by the data transceiver 822 in the memory 7, requests the operating system 100a to create the internal socket 802, and notifies the created internal socket to the data transceiver 822. In the same way as the aforementioned embodiments, the data transceiver 822 temporarily stores a data object, for example, such data as content or program, received through a communication socket meant for communicating with an external server in the local memory 823a. Then the data transceiver 822 reads the stored data of the data object and provides the data object processor 810 with the data through the internal socket 801 created in the data object processor 810 in response to the internal socket 802. Meanwhile, as for the internal socket 802, the channel builder 823 may form the internal socket 802 when the operating system 100a requests creation of the corresponding internal socket according to an internal socket request of the media player 810.

The data transceiver 822 performs the same operation as described for the data transceiver 112 in the previous embodiments except that the local memory 823a and the internal socket 802 are used as a data channel to deliver data of a received data object to the data object processor 810. The data transceiver 822, by calling for appropriate mediation of the operating system 100a, delivers the data of a data object received and stored in the local memory 823a to the data object processor 810 through the internal socket 802, thereby making the data of the data object used for the intended function described previously (decoding, storing, and executing thereof).

The data transceiver 822 receives a data object by downloading in case the attribute of the data object is not media of video or audio. The data transceiver 822 can receive the data object through downloading rather than streaming even if the attribute thereof is media. As described above, even when the data object is received through downloading, the data transceiver 822 can determine the reference value for the amount of remaining data as in the embodiments described above and use the reference value for determining whether to perform connection switching of communication networks. Since temporary disconnection of data provided through the data channel 823a, 802 does not occur in the case of downloading, the time (or the amount of data expected to be received during the time period) required until underrun (the state where all of the received data have been provided through the internal socket 802 and there is no remaining data) of the local memory 823a occurs may not be used as the reference value for the amount of remaining data. The data transceiver 822 transmits a request compliant with communication protocol, which is received through the internal socket 801, 802 from the data object processor 810, through the operating system 100a to the outside. And the data transceiver 822 provides a response received with respect to the request to the data object processor 810 through the data channel 823a, 802 and at the same time, analyzes file information included in the response, by which whether the response is processed through streaming or downloading can be known.

In one embodiment according to the present invention, functions implemented within the data transceiver 820, namely, the function described above, which in response to the request compliant with communication protocol demanding a data object from the data object processor 810, reads data of the data object from the local memory 823a and provides the data to the data object processor 810 through the internal socket 802; and the function described above, which receives data of a data object from an external server through the operating system 100a, stores the received data in the local memory 823a, and determines whether to perform connection switching between communication networks according to the amount of remaining data by setting up a reference value if needed but performs continuous downloading in case connection switching between communication networks is performed, can be implemented as separate processes distinguished from each other.

Meanwhile, the internal socket 801, 802 between the data object processor 810 and the media agent 820 is created for both applications or processes by specifying a particular IP address, for example, “127.0.0.1” or “localhost” intended to inform the operating system 100a that the particular IP address is an internal IP address; or a port number assigned to a corresponding application or process trying to create an internal socket.

In another embodiment according to the present invention, a data channel can be implemented by an inter-process communication (IPC) method supported by the operating system 100a rather than using an internal communication socket, by which media data can be delivered to the data object processor 810.

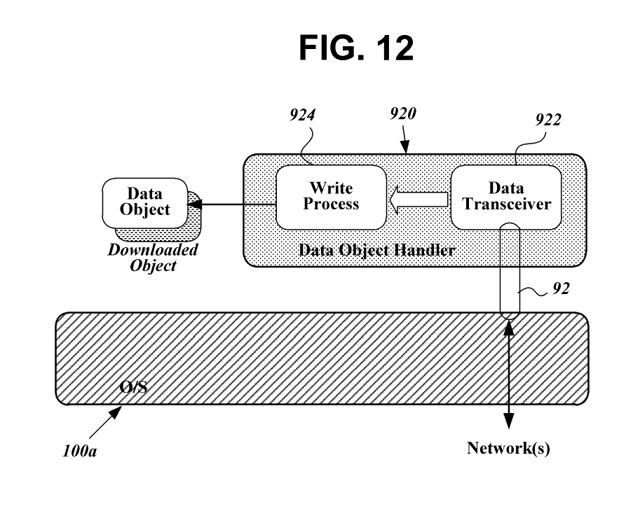

In one embodiment according to the present invention, a method for determining connection switching between communication networks according to the amount of remaining data to receive described above can be implemented within the data object processor which carries out the function intended for data objects (decoding, storing, and executing thereof). FIG. 12 illustrates a structure of a data object processor 920 according to one embodiment of the present invention in conjunction with a related structure, where the structure of the data object processor comprises a data transceiver 922 and a record processor 924. The data transceiver 922 of the present embodiment carries out the same operation as the determination of connection switching according to the amount of remaining data and continuous downloading at the time of connection switching, which are described with respect to the data transceiver 822 of the embodiment of FIG. 11. However, the data transceiver 922 does not directly perform the process of delivering a data object received by a different process through the data channel such as the internal socket 802. Instead of performing the process above, the data transceiver 922 performs the operation of delivering data of a data object received through a communication socket 92 created through the operating system 100a to the record processor 924. The record processor 924 temporarily stores the data object received from the data transceiver 924 in a storage means, for example, the memory 7 as a single entity or records the data object as a single file in a file system. Afterwards, the entity or file recorded as described above can be referenced and used by a different process.

In case a plurality of segment files with respect to one selected content are provided consecutively according to a request, the method for determining connection switching of communication networks according to the amount of remaining data to receive described so far can be applied naturally to each of the segment files. In the present embodiment, each segment file can correspond to the data object described above. In case live video is provided in a form of segment files according to HTTP Live Streaming (HLS) specifications with respect to selected media content, for example, a particular sport broadcasting program, whether to perform connection switching is determined according to the amount of remaining data to receive with respect to a currently requested and received segment file. In the case of a segment file according to the HLS specifications, play time thereof can be known through a list of segment files provided for obtaining the respective segment files.

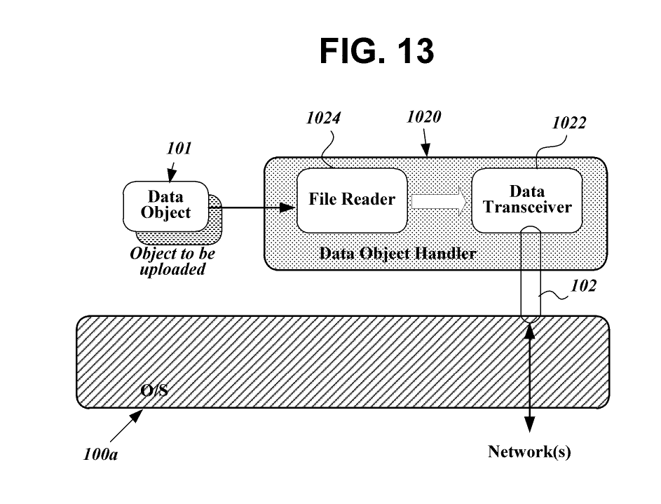

The technical principles and concept applied to the method for determining connection switching of communication networks described above can be applied the same for the case where the mobile communication terminal 100 uploads a data object to a particular external server. In this case, the reference value for the amount of remaining data is applied to comparison with the amount of remaining data to transmit yet; instead of using a receiving speed, a transmission speed is used for converting the reference value or size for the amount of remaining data to the same physical units. FIG. 13 illustrates a structure of a data object processor 1020 according to an embodiment of the present invention. The data object processor 1020 according to the present embodiment can comprise a data transceiver 1022 and a file reader 1024 as shown in the figure. Also, the data object processor 1020 can be constructed so that it includes a UI processing unit which enables the user to designate a data object to transmit and a server at a transmitter-side by providing the user with an appropriate input screen.

Suppose a uploading server is designated by the UI processing unit or a different application. Then in the data object processing unit 1020, the data transceiver 1022 receives the information about the designation and based on the information, requests the operation system 100a to create a communication socket 102 with which the data transceiver 1022 can communicate with the corresponding server. Next, with respect to the file 101 of a data object stored in the memory 7, which is designated by the UI processing unit or a different application, if the file reader 1024 reads and delivers the data of the file sequentially, the data transceiver 1022 transmits the delivered data through the created communication socket 102 so that the delivered data can be stored in the corresponding server. During the transmission process, the data transceiver 1022 figures out a data transmission speed by checking the amount of transmitting data for a predetermined time period and checks information about the amount of remaining data to receive by consulting the file reader 1024. In another implementation, at the initial transmission request for a data object from the file reader 1024, the overall size is checked and by subtracting the total amount of data transmitted through the communication socket 102 from the overall size, the amount of remaining data to transmit can be known independently. In the present embodiment, if the operations described in the previous embodiments correspond to the operations performed when the amount of remaining data to receive and a receiving speed are replaced respectively with the amount of remaining data to transmit and a transmission speed, for example, if the current state satisfies the condition for connection switching described above, the data transceiver 1022 carries out the operation of comparing the amount of remaining data to transmit with the reference value for the amount of remaining data determined or adjusted according to the method described above and the operation of determining whether to perform connection switching according to the comparison result.

The previous embodiments, which describe determination of network switching according to the amount of remaining data to receive or to transmit, have dealt with connection switching between heterogeneous networks, namely, connection switching between a cellular network and a Wi-Fi network as an example. However, the determination of connection switching according to the amount of remaining data not completely transmitted and associated determination or adjustment of a reference value for the amount of remaining data can also be applied to connection switching among different access points within homogeneous communication networks compliant with the same communication protocol. For example, in the environment of a plurality of heterogeneous communication networks, connection switching can also be determined by comparing the amount of remaining data to receive or to transmit with the reference value for the amount of remaining data determined according to one of the methods described above if a mobile communication terminal needs to perform connection switching to a different access point as the different access point rather than the access point to which the mobile communication terminal is currently connected becomes available (the availability thereof can be checked by response information in accordance to a search request on the operating system of the corresponding terminal), and service quality of the different access point is deemed to be superior to that of the current access point (for example, as the signal strength of the different access point is higher, or a quality-related grade or expected transmission speed with respect to the different access point is higher than that of the current access point), while the mobile communication terminal capable of accessing a single communication network or the plurality of communication networks is connected to the Wi-Fi network 11b and receives or transmits content data. The aforementioned scheme can also be applied when the different access point becomes available and the communication state of the current access point is not in a good condition (for example, when the amount of unprocessed data of the data channel is decreasing). In this document, therefore, connection switching between communication networks or access points is called collectively “connection switching”.

In another embodiment according to the present invention, the variables proposed in the previous embodiments as the reference value for the amount of remaining data can be used jointly for determining whether to perform connection switching if they are compatible with each other. For example, if a mobile communication terminal is unable to receive all of content data within a reception time limit though it is possible to receive all of the data within estimated underrun time of a data channel (for example, a buffer), connection switching may be carried out. Similarly, if the mobile communication terminal is unable to receive or transmit all of the data within a time period determined by a weight factor of the time required for switching communication networks though it is possible to receive or transmit the data completely within the reception time limit, the connection switching may be carried out. Such a combination of the variables above is just an example, and other various combinations of the variables compatible with each other can also be used for determining whether to perform connection switching.

So far, the technical principles and concept of the present invention have been described in detail by using a high-speed wireless LAN network as an example of a data communication network used together with a mobile phone communication network called a cellular network for providing data services. The technical principles and concept of the present invention can be applied the same for a communication network different from the Wi-Fi network if the different communication network requires no cost to a user using a data service; or if the different communication network causes a charge, excluding the fixed cost, smaller than the cellular network (in other words, if a data service through the different communication network introduces smaller charges on the user) or exhibits weak service reliability due to limited availability only in a scattered, local service area of access points. Therefore, it should be understood that the technical scope defined by appended claims cannot be excluded only because a data communication network to which the present invention is applied is different from the Wi-Fi network. At this time, the fixed cost refers to the cost already determined from the use of a data service up to a current time point regardless of an additional use of the data service.

The embodiments of the present invention described above have been introduced for the purpose of illustration; therefore, it should be understood by those skilled in the art that modification, change, substitution, or addition to the embodiments is possible without departing from the technical principles and scope of the present invention defined by the appended claims.

1. A mobile communication terminal capable of accessing a wireless communication network, comprising:
a data processing unit adapted to conduct an intended operation for a data object; and
a data transceiver configured
to receive data of a data object from an external server, in a state of being connected to a communication network among a plurality of heterogeneous networks including a first communication network and a second communication network, through the connected communication network,
to check an amount of remaining data, not received, of the data object while providing the received data to the data processing unit, and
in case of a current state being corresponding to one of conditions for connection switching, to switch connection if a value reflecting the checked amount of remaining data is greater than a value of a determined criterion, and not to switch connection if smaller than the value of the determined criterion.

2. The mobile communication terminal of claim 1, wherein the conditions for connection switching comprise at least one of:
a first condition that a communication network or an access point through which data of the data object is received is in a poor communication state;
a second condition that another communication network providing better service quality than a communication network through which data of the data object is received is available;
a third condition that another access point providing better communication property than an access point through which data of the data object is received is available; and
a fourth condition that another communication network requiring no cost to a user using a data service or a smaller cost, excluding fixed cost, than a communication network through which data of the data object is received is available.

3. The mobile communication terminal of claim 2, wherein the data transceiver is configured to deem that the first condition is satisfied if an amount of remaining data, not provided to the data processing unit, in a data channel is decreasing, the data channel being used for delivering data of the data object to the data processing unit.

4. The mobile communication terminal of claim 1, wherein the data transceiver is configured to: check an amount of currently unprocessed data, not provided to the processing unit, in a data channel; calculate time required for the checked amount of unprocessed data to be exhausted; and determine the criterion based on the calculated time, the data channel being used for delivering data of the data object to the data processing unit.

5-6. (canceled)

7. The mobile communication terminal of claim 1, wherein the data transceiver is configured to determine the criterion based on switching time required for connection switching.

8. The mobile communication terminal of claim 7, wherein the switching time is determined to be a time corresponding to the connection switching chosen from among time values set respectively with respect to switching from the first communication network to the second communication network, switching from the second communication network to the first communication network, and switching between access points belonging to the second communication network, and wherein the second communication network is a network whose service areas are relatively localized and scattered compared with those of the first communication network.

9. The mobile communication terminal of claim 7, wherein the switching time is obtained from an average of time values corresponding to the connection switching among collected time values required for connection between the first communication network and an arbitrary access point belonging to the second communication network or between an arbitrary pair of access points belonging to the second communication network, and wherein the second communication network is a network whose service areas are relatively localized and scattered compared with those of the first communication network.

10. The mobile communication terminal of claim 1, wherein the data transceiver is configured to determine the criterion to be a time obtained by subtracting elapsed time during the data receiving from a time specified for completion of receiving the data object, or to be currently remaining time until a point of time specified for completion of receiving the data object.

11. The mobile communication terminal of claim 1, wherein the data transceiver is further configured to compare the value reflecting the checked amount of remaining data with respective values set according to a plurality of predetermined criteria, and not to switch connection in case that the value reflecting the checked amount is smaller than each of the values.

12. The mobile communication terminal of claim 1, wherein the data transceiver is configured to reduce relative magnitude of a value of the criterion to a value reflecting the amount of remaining data if a speed of receiving data of the data object is decreased.

13-14. (canceled)

15. The mobile communication terminal of claim 1, wherein the connection switching is to be made between the first communication network and the second communication network or between access points belonging to the second communication network, and the second communication network is a network whose service areas are relatively localized and scattered compared with those of the first communication network.

16. (canceled)

17. The mobile communication terminal of claim 1, wherein the data transceiver is further configured to set the criterion applied for the connection switching to be made from the first communication network to the second communication network lower than the criterion applied for the connection switching to be made from the second communication network to the first communication network, and the second communication network requires no cost to a user using a data service or a smaller cost, excluding fixed cost, than the first communication network.

18. The mobile communication terminal of claim 1, wherein the data transceiver is further configured to let down the determined criterion, if a current mode is meant to restrain incurrence of cost and a currently connected communication network is the first communication network, in case that the connection switching is to be made between the first communication network and the second communication network and the second communication network requires no cost to a user using a data service or a smaller cost, excluding fixed cost, than the first communication network.

19. The mobile communication terminal of claim 1, wherein the data transceiver is further configured to raise the determined criterion, if a current mode is meant to put a high priority on convenience in using data service and a currently connected communication network is the first communication network, in case that the connection switching is to be made between the first communication network and the second communication network and the second communication network requires no cost to a user using a data service or a smaller cost, excluding fixed cost, than the first communication network.

20. The mobile communication terminal of claim 1, further comprising a mode determining unit configured to determine a mode automatically, from among a plurality of modes including a mode meant to restrain incurrence of cost and a mode meant to put a high priority on convenience in using data service, based on data usage with respect to the first communication network, a rate schedule information of a user, and a remaining days in terms of a rate schedule period,
wherein the data transceiver is further configured to selectively adjust the determined criterion according to the determined mode.

21. The mobile communication terminal of claim 1, wherein the data transceiver is further configured to let down the determined criterion if a variation range of communication property of a communication network or an access point currently connected is larger than a predetermined limit, and the communication property includes strength of a received signal or a data receiving speed.

22. The mobile communication terminal of claim 1, wherein the data transceiver is further configured to raise the determined criterion if a variation range of communication property of a target communication network or a target access point to which connection is switched is larger than a predetermined limit, and the communication property includes strength of a received signal or a data receiving speed.

23. The mobile communication terminal of claim 1, wherein the data transceiver is further configured to let down the determined criterion if communication property of a target communication network or a target access point to which connection is switched is better than a predetermined reference, and the communication property includes strength of a received signal or a data receiving speed.

24. The mobile communication terminal of claim 1, wherein the data transceiver is configured to adjust the determined criterion based on length of a time obtained by subtracting elapsed time during the data receiving from a time specified for completion of receiving the data object, or based on length of a currently remaining time until a point of time specified for completion of receiving the data object.

25-29. (canceled)

30. A mobile communication terminal capable of accessing a wireless communication network, comprising:
a data obtaining unit configured to obtain data of a selected data object; and
a data transceiver configured
to check an amount of remaining data, not transmitted, of the data object while transmitting data of the data object being obtained by the data obtaining unit to an external server in a state of being connected to one communication network among a plurality of heterogeneous networks, and
in case of a current state being corresponding to one of conditions for connection switching, to switch connection if a value reflecting the checked amount of remaining data is greater than a value of a determined criterion, and not to switch connection if smaller than the value of the criterion.

31. A method for receiving data as switching connection selectively, the method conducted by a mobile communication terminal comprising:
a first step of receiving data of a data object from an external server through a connected network in an environment of a plurality of heterogeneous networks;
a second step of checking an amount of remaining data, not received, of the data object while providing the received data to a processing unit for conducting an intended operation for the data object; and
a third step of in case of a current state being corresponding to one of conditions for connection switching, comparing a value reflecting the checked amount of remaining data with a value of a determined criterion and switching connection selectively according to a result of the comparing,
wherein the third step does not switch connection of the mobile communication terminal if the value reflecting the amount of remaining data is smaller than the value of the determined criterion.

32. (canceled)

33. A method for transmitting data as switching connection selectively, the method conducted by a mobile communication terminal comprising:
a first step of obtaining data of a selected data object;
a second step of checking an amount of remaining data, not transmitted, of the data object while transmitting the obtained data to an external server through a connected network in an environment of a plurality of heterogeneous networks; and
a third step of in case of a current state being corresponding to one of conditions for connection switching, comparing a value reflecting the checked amount of remaining data with a value of a determined criterion and switching connection selectively according to a result of the comparing,
wherein the third step does not switch connection of the mobile communication terminal if the value reflecting the amount of remaining data is smaller than the value of the determined criterion.

34-35. (canceled)

36. An apparatus equipped with a storage storing for programs to be provided through a network, comprising:
communication means being capable of transceiving data through communication with an outside entity; and
storing means storing an application to be run on a mobile communication terminal, the application being transmitted through the communication means,
wherein the application includes a program structure to accomplish operations, in case of being run on the mobile communication terminal, that comprise:
receiving data of a data object from an external server, in a state of being connected to a communication networks in an environment of a plurality of heterogeneous networks, through the connected communication network; and
checking an amount of remaining data, not received, of the data object;
in case of a current state being corresponding to one of conditions for connection switching, retaining current connection of the mobile communication terminal if a value reflecting the checked amount of the remaining data is smaller than a value of a determined criterion, but switching connection if larger than the value of the determined criterion.

37. An apparatus equipped with a storage storing for programs to be provided through a network, comprising:
communication means being capable of transceiving data through communication with an outside entity; and
storing means storing an application to be run on a mobile communication terminal, the application being transmitted through the communication means,
wherein the application includes a program structure to accomplish operations, in case of being run on the mobile communication terminal, that comprise:
obtaining data of a selected data object;
transmitting data of the data object to an external server, in a state of being connected to a communication network in an environment of a plurality of heterogeneous networks, through the connected communication network;
checking an amount of remaining data, not transmitted, of the data object; and
in case of a current state being corresponding to one of conditions for connection switching, retaining current connection of the mobile communication terminal if a value reflecting the checked amount of remaining data is smaller than a value of a determined criterion, but switching connection if larger than the value of the determined criterion.

38. The mobile communication terminal of claim 1, wherein the intended operation for the data object is decoding the data object or recording the data object in a storage means.
